(19) United States
(12) Patent Application Publication
(10) Pub. No.: US 2023/0392050 A1
(43) Pub. Date: Dec. 7, 2023

(54) AIRTIGHT PRESSURE-SENSITIVE ADHESIVE TAPE FOR FOUNDATION

(71) Applicant: Maxell, Ltd., Kyoto (JP)

(72) Inventor: Mizuki TACHIBANA, Otokuni-gun (JP)

(21) Appl. No.: 18/321,932

(22) Filed: May 23, 2023

(30) Foreign Application Priority Data
Jun. 3, 2022 (JP) 2022-091122
Mar. 30, 2023 (JP) 2023-055278

(51) Int. Cl. C09J 7/26; C09J 7/24; C09J 7/38

(52) U.S. Cl. CPC C09J 7/26; C09J 2301/204; C09J 7/385; C09J 7/243

(57) ABSTRACT

Provided is an airtight member for foundation superior in sealing performance on a side surface and a bottom surface of a sill and capable of easily adjusting an installation position thereof. An airtight pressure-sensitive adhesive tape for foundation having: a band-shaped airtight elastic sheet having a front surface, a back surface and two side edge portions opposing each other; a virtual L-shape fold line located away from one of the side edge portions of the elastic sheet toward the inside of the elastic sheet; and a band-shaped pressure-sensitive adhesive layer being parallel to the side edge portions of the elastic sheet and being formed in a region of the front surface of the elastic sheet extending from one of the side edge portions up to the virtual L-shape fold line; and having no pressure-sensitive adhesive layer on other regions of the front surface and the back surface of the elastic sheet.

### CROSS-REFERENCE TO RELATED APPLICATION

This application claims the benefit under Article 4 of the Paris Convention based on Japanese Patent Application No. 2022-91122 filed on Jun. 3, 2022 and No. 2023-55278 filed on Mar. 30, 2023 incorporated herein by reference in their entirely.

### TECHNICAL FIELD

The present invention relates to an airtight member to be used for construction around the foundation of a wooden building, and more particularly to an airtight pressure-sensitive adhesive tape for foundation that seals a gap between a foundation and a sill in a foundation heat insulation method.

### BACKGROUND ART

FIG. 1 is a cross-sectional view illustrating one example of a structure around a foundation of a wooden building. As understood from FIG. 1, a wooden building is built, for example, by forming a foundation 12, in which anchor bolts 14 are embedded at prescribed intervals, from reinforced concrete or the like in the ground or on the ground surface 11, stacking a wooden sill 13 on the foundation 12, fixing the sill 13 to the anchor bolt 14 protruding above the foundation, erecting a column 15 on the top surface of the sill 13, and attaching an exterior wall 16 to the side surface on the outdoor B side of the sill 13 and the column 15. On the indoor A side, a floor 17 and the like are formed.

In a wooden house building, the foundation heat insulation method is a method in which the concrete itself of a foundation is covered with a heat insulating material to prevent outside hot air and cold air from affecting the indoor temperature. In the case of foundation heat insulation, since an underfloor space is also considered as an indoor space, when outside air enters the underfloor space, the indoor temperature is affected. For this, a measure for ensuring airtightness is taken by sealing a gap between a foundation and a sill of a building or a gap between an exterior wall and a side surface in order to prevent outside air from entering indoors.

Patent Document 1 describes an airtight member for foundation 100 comprising a foam sheet 105 with a pressure-sensitive adhesive that will be sandwiched between the top surface of a foundation and the bottom surface of a sill, and a sealing sheet 115 with a pressure-sensitive adhesive that is connected in a T shape to the foam sheet with a pressure-sensitive adhesive at a side edge portion thereof on the exterior wall side. With the airtight member for foundation 100 of Patent Document 1, the sealing sheet 115 with a pressure-sensitive adhesive connects the foundation and the sill over the side surfaces thereof along a boundary between the foundation and the sill, and thereby a gap between the foundation and the sill is sealed (FIG. 1 and FIG. 2).

### Patent Document

Patent Document 1: U.S. Pat. No. 6,676,779

### SUMMARY

### Problems to be Solved by the Invention

On the other hand, the foundation has irregularities on the top surface and the side surfaces, and when the foam sheet 105 with a pressure-sensitive adhesive and the sealing sheet 115 with a pressure-sensitive adhesive are bonded to those surfaces, the foam sheet 105 is corrugated, and the sheet 115 with a pressure-sensitive adhesive is distorted and wrinkled. Since the wrinkled portion of the sealing sheet 115 with a pressure-sensitive adhesive floats off the side surface of the foundation or the sill, which is the adherend surface, there is a problem that outside air enters the building through the floating portion, and it is difficult to achieve sufficient airtightness.

In addition, since the foam sheet 105 with a pressure-sensitive adhesive is bonded to the top surface of the foundation with the pressure-sensitive adhesive when being installed on the foundation, there also is a problem that it is difficult to move the airtight member for foundation 100 once installed, and it is difficult to adjust the arrangement of the foam sheet 105 with a pressure-sensitive adhesive so that wrinkles do not occur in the foam sheet 105 with a pressure-sensitive adhesive.

The present invention solves the above problems, and an object of the present invention is to provide an airtight pressure-sensitive adhesive tape for foundation that can simultaneously seal a side surface and a bottom surface of a sill and can easily adjust an installation position.

A further object of the present invention is to provide an airtight pressure-sensitive adhesive tape for foundation that can be easily installed with superior positional accuracy on a foundation from which anchor bolts protrude at prescribed intervals.

A further object of the present invention is to provide an airtight pressure-sensitive adhesive tape for foundation having superior airtight performance.

### Solutions to the Problems

Embodiments of the present invention are described below.

### Embodiment 1

An airtight pressure-sensitive adhesive tape for foundation having: a band-shaped airtight elastic sheet having a front surface, a back surface and two side edge portions opposing each other, and a portion having a pressure-sensitive adhesive layer and a portion having no pressure-sensitive adhesive layer on the elastic sheet; and having a pressure-sensitive adhesive layer extending from one of the side edge portions of the elastic sheet toward the other side edge portion in a partial region of a distance from one of the side edge portions to the other side edge portion.

### Embodiment 2

The airtight pressure-sensitive adhesive tape for foundation according to Embodiment 1, wherein a distance of the portion having no pressure-sensitive adhesive layer located between one of the side edge portions and the other side edge portion is substantially the same as a width of the sill.

### Embodiment 3

The airtight pressure-sensitive adhesive tape for foundation according to Embodiment 1 or 2, wherein a distance of the portion having no pressure-sensitive adhesive layer located between one of the side edge portions and the other side edge portion is from 90 mm to 410 mm.

### Embodiment 4

An airtight pressure-sensitive adhesive tape for foundation having: a band-shaped airtight elastic sheet having a front surface, a back surface and two parallel side edge portions opposing each other; a virtual L-shape fold line being parallel to the side edge portions and located away from one of the side edge portions of the elastic sheet toward the inside of the elastic sheet; and a band-shaped pressure-sensitive adhesive layer being parallel to the side edge portions and being formed in a region of the front surface of the elastic sheet extending from one of the side edge portions up to the virtual L-shape fold line; and having no pressure-sensitive adhesive layer on other regions of the front surface and the back surface of the elastic sheet.

### Embodiment 5

The airtight pressure-sensitive adhesive tape for foundation according to any one of Embodiments 1 to 4, wherein the airtight pressure-sensitive adhesive tape has a row of a plurality of holes for anchor bolt penetration, the holes being formed in a region extending from a side edge portion of the elastic sheet on a side where no pressure-sensitive adhesive layer is formed before the pressure-sensitive adhesive layer and being aligned parallel to the side edge portion at regulated intervals, the holes for anchor bolt penetration having a slit shape.

### Embodiment 6

The airtight pressure-sensitive adhesive tape for foundation according to Embodiment 5, having 1 to 5 rows of the row of holes for anchor bolt penetration.

### Embodiment 7

The airtight pressure-sensitive adhesive tape for foundation according to any one of Embodiment 1 to 6, wherein the elastic sheet is made of an elastic resin foam.

### Embodiment 8

The airtight pressure-sensitive adhesive tape for foundation according to any one of Embodiment 1 to 7, wherein the elastic sheet has a durometer E hardness in a range of from 4 to 41 at room temperature.

### Embodiment 9

The airtight pressure-sensitive adhesive tape for foundation according to any one of Embodiment 1 to 8, wherein the elastic sheet has a moisture permeability of 32 g/m²·24 h or less measured in accordance with JIS Z 0208:1976 at room temperature.

### Embodiment 10

The airtight pressure-sensitive adhesive tape for foundation according to any one of Embodiment 1 to 9, wherein the elastic sheet has a thickness in a range of from 2 mm to 30 mm or less.

### Embodiment 11

The airtight pressure-sensitive adhesive tape for foundation according to Embodiment 7, wherein the elastic sheet formed of the elastic resin foam has a 50% compressive stress of from 10 kPa to 200 kPa measured in accordance with JIS K 6767 at room temperature.

### Embodiment 12

The airtight pressure-sensitive adhesive tape for foundation according to any one of Embodiment 7 to 11, wherein the elastic resin comprises an ethylene-propylene-diene rubber or polyethylene.

### Embodiment 13

The airtight pressure-sensitive adhesive tape for foundation according to any one of Embodiment 1 to 12, wherein the pressure-sensitive adhesive layer comprises an acrylic or rubber-based pressure-sensitive adhesive.

### Embodiment 14

The airtight pressure-sensitive adhesive tape for foundation according to any one of Embodiment 1 to 13, wherein the pressure-sensitive adhesive layer has a width dimension in a range of from 5 mm to 100 mm.

### Embodiment 15

A method of airtight damp-proofing a wooden building, the method comprising:
a step of arranging the elastic sheet of the airtight pressure-sensitive adhesive tape for foundation according to any one of Embodiment 1 to 14 between a top surface of a foundation and a bottom surface of a sill such that a portion of the front surface of the elastic sheet extending from the side edge portion on a side where the pressure-sensitive adhesive layer is not formed up to the virtual L-shape fold line is in contact with the bottom surface of the sill;
a step of folding up a portion of the elastic sheet extending from the side edge portion on a side where the pressure-sensitive adhesive layer is formed to the virtual L-shape fold line along the virtual L-shape fold line in a direction in which the pressure-sensitive adhesive layer faces inward to bond the pressure-sensitive adhesive layer to the side surface of the sill; and
installing a wall member such that the wall member is in contact with the elastic sheet of the airtight pressure-sensitive adhesive tape for foundation bonded on a side surface of a sill.

### Embodiment 16

A building comprising the airtight pressure-sensitive adhesive tape for foundation according to any one of Embodiment 1 to 14.

### Effects of the Invention

According to the present invention, there is provided an airtight pressure-sensitive adhesive tape for foundation capable of simultaneously sealing a side surface and a bottom surface of a sill and easily adjusting an installation position. Furthermore, a building using this airtight pressure-sensitive adhesive tape for foundation can be provided.

In one embodiment, the airtight pressure-sensitive adhesive tape for foundation of the present invention can be easily installed on a foundation on which anchor bolts protrude at prescribed intervals with superior positional accuracy.

In one embodiment, the airtight pressure-sensitive adhesive tape for foundation of the present invention is superior in airtight performance.

### BRIEF DESCRIPTION OF DRAWINGS

FIG. 1 is a cross-sectional view illustrating one example of a structure around a foundation of a wooden building;

FIG. 2 is a perspective view illustrating one example of the configuration of an airtight pressure-sensitive adhesive tape for foundation of the present invention;

FIG. 3 is a perspective view illustrating another example of the configuration of an airtight pressure-sensitive adhesive tape for foundation of the present invention;

FIGS. 4A to 4C are perspective views illustrating one example of an airtight damp-proofing method for a wooden building using the airtight pressure-sensitive adhesive tape for foundation of the present invention;

FIGS. 5A and 5B include a plan view and a cross-sectional view for explaining a method of preparing a test body to be subjected to an airtightness test of a resin foam sheet used in the airtight pressure-sensitive adhesive tape for foundation of the present invention, wherein FIG. 5A illustrates a first step, and FIG. 5B illustrates a second step;

FIGS. 5C and 5D includes a plan view and a cross-sectional view for explaining a method of preparing a test body to be subjected to an airtightness test of a resin foam sheet used in the airtight pressure-sensitive adhesive tape for foundation of the present invention, wherein FIG. 5C illustrates a third step and FIG. 5D illustrates a fourth step;

FIGS. 5E and 5F includes a plan view and a cross-sectional view for explaining a method of preparing a test body to be subjected to an airtightness test of a resin foam sheet used in the airtight pressure-sensitive adhesive tape for foundation of the present invention, wherein FIG. 5E illustrates a fifth step and FIG. 5F illustrates a sixth step; and

FIG. 6 is a schematic cross-sectional view for explaining a method of testing airtightness of a resin foam sheet used in the airtight pressure-sensitive adhesive tape for foundation of the present invention.

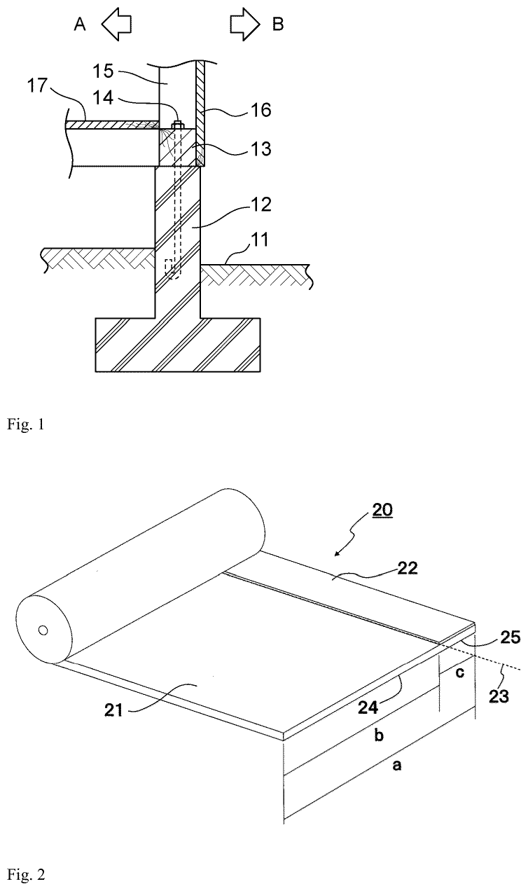

### DETAILED DESCRIPTION

In the present specification, the airtight pressure-sensitive adhesive tape for foundation refers to a pressure-sensitive adhesive tape for use for ensuring airtightness by sealing a gap between a foundation and a sill and/or a gap between an exterior wall and a side surface of a building so that outside air does not enter indoors. The airtight pressure-sensitive adhesive tape for foundation of the present invention is configured to be foldable into an L shape along a prescribed line parallel to the side edge portions of the pressure-sensitive adhesive tape such that the pressure-sensitive adhesive tape can, as a result of the installation thereof, seal at once an L-shaped gap formed by a gap between a foundation and a sill and a gap between an exterior wall and a sill side surface both vertically rising at the exterior wall side end of the aforementioned gap. The airtight pressure-sensitive adhesive tape is bonded and fixed only to the sill side surface by a pressure-sensitive adhesive layer. The airtight pressure-sensitive adhesive tape for foundation may have, for example, a flat sheet shape or a rolled-up roll shape.

### Airtight Pressure-Sensitive Adhesive Tape for Foundation

FIG. 2 is a perspective view illustrating one example of the configuration of an airtight pressure-sensitive adhesive tape for foundation of the present invention. The airtight pressure-sensitive adhesive tape for foundation 20 of FIG. 2 has a band-shaped elastic sheet 21, a band-shaped pressure-sensitive adhesive layer 22 formed on the front surface of the elastic sheet 21, and a virtual L-shape fold line 23 that is parallel to the side edge portions of the elastic sheet. On a surface of the pressure-sensitive adhesive layer 22 is laminated a release sheet (not shown) for protecting the surface until the pressure-sensitive adhesive layer is bonded to an adherend. The airtight pressure-sensitive adhesive tape for foundation 20 shown in FIG. 2 is in a state in which a part of the tape has been pulled out from a rolled-up roll.

### Elastic Sheet

The elastic sheet 21 has a front surface, a back surface and two side edge portions opposing each other, and has a portion having a pressure-sensitive adhesive layer and a portion having no pressure-sensitive adhesive layer. The elastic sheet has a pressure-sensitive adhesive layer extending from one of the side edge portions of the elastic sheet toward the other side edge portion in a partial region of a distance from one of the side edge portions to the other side edge portion. A distance of a portion having no pressure-sensitive adhesive layer between one of the side edge portions and the other side edge portion of the elastic sheet is substantially the same as the width of a sill. In addition, the distance of a portion having no pressure-sensitive adhesive layer between one of the side edge portions and the other side edge portion is in a range of from 90 mm to 410 mm.

The elastic sheet 21 has a front surface, a back surface and two parallel side edge portions opposing each other. The virtual L-shape fold line 23 exists at a position away from one of the side edge portions of the elastic sheet toward the inside of the elastic sheet.

In the elastic sheet 21, a portion from the side edge portion on the front side up to the virtual L-shape fold line 23 illustrated in FIG. 2 is an underlay portion 24 to be sandwiched between the top surface of a foundation and the bottom surface of a sill when the airtight pressure-sensitive adhesive tape for foundation 20 is used. In addition, a portion extending from the virtual L-shape fold line 23 to the side edge portion on the far side shown in FIG. 2 is a fold-up portion 25 to be folded up and bonded to the side surface of the sill.

Neither the front surface nor the back surface of the underlay portion 24 has thereon any pressure-sensitive adhesive layer. For this, when the airtight pressure-sensitive adhesive tape for foundation is installed on a foundation, the elastic sheet 21 is not bonded to the top surface of the foundation, and for example, the installation position can be easily adjusted in consideration of the arrangement with which airtightness can be optimized. The elastic sheet 21 is folded up substantially perpendicularly along the virtual L-shape fold line 23 in a direction in which the pressure-sensitive adhesive layer 22 faces inward, and is bonded to the side surface of the sill by the pressure-sensitive adhesive layer 22, so that an L-shaped form is formed. No pressure-sensitive adhesive layer is usually formed on the back surface of the fold-up portion 25, but a pressure-sensitive adhesive layer may be formed, as necessary.

The dimensions of the elastic sheet 21 are adjusted in consideration of the dimensions of the sill to be used. It is sufficient that the dimensions of the elastic sheet 21 are matched with the dimensions of the sill to such an extent that the sealing function of the airtight member for foundation is exhibited. The width a of the elastic sheet 21 is the sum of the width b of the underlay portion 24 and the width c of the fold-up portion 25. The width b of the underlay portion 24 is preferably substantially equal to the width of the sill. As an example, the width b is about 90 mm in the 2×4 method, about 140 mm in the 2×6 method, and about 184 mm in the 2×8 method. The width c of the fold-up portion 25 is preferably substantially equal to the height of the sill.

In one embodiment, the width a of the elastic sheet 21 is in a range of from 100 mm to 500 mm, preferably from 150 mm to 300 mm, and more preferably from 224 mm to 250 mm. In one embodiment, the width c of the fold-up portion 25 is in a range of from 10 mm to 90 mm, preferably from 20 mm to 70 mm, and more preferably from 30 mm to 50 mm. The width b of the underlay portion 24 is in a range of from 90 mm to 410 mm.

The thickness of the elastic sheet 21 is appropriately determined in dependence on the degree of irregularities on the top surface of the foundation, and is generally in a range of from 2 mm to 30 mm, preferably from 3 mm to 15 mm, and more preferably from 4 mm to 10 mm. When the thickness of the elastic sheet 21 is less than 2 mm, insufficient followability to irregularities on the top surface of the foundation is provided. When the thickness exceeds 30 mm, a large weight of the airtight pressure-sensitive adhesive tape for foundation is provided, which is not preferable. In addition, there is a possibility that it is difficult to fold up the fold-up portion 25 or to wind the fold-up portion into a roll shape.

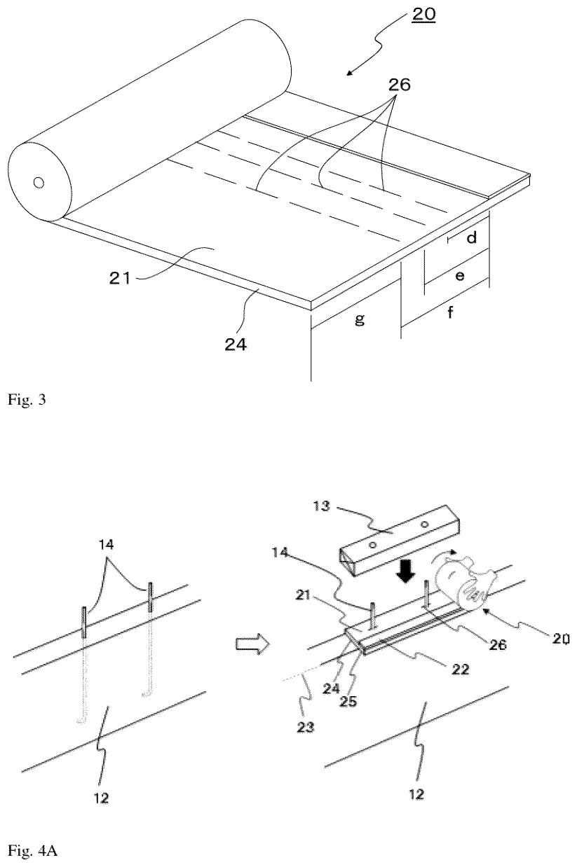

FIG. 3 is a perspective view illustrating another example of the configuration of an airtight pressure-sensitive adhesive tape for foundation 20 of the present invention. The airtight pressure-sensitive adhesive tape for foundation 20 of FIG. 3 has a row 26 of holes for allowing anchor bolts to pass through the underlay portion 24 of the elastic sheet 21 (hereinafter, the hole may be referred to as a “hole for anchor bolt penetration”). Three rows 26 of holes for anchor bolt penetration are formed and aligned in parallel with the side edge portions. Generally, the intervals between the rows 26 of holes for anchor bolt penetration are regular. Other configurations are the same as those of the airtight pressure-sensitive adhesive tape for foundation shown in FIG. 2. Owing to the configuration that the underlay portion 24 has the row 26 of holes for anchor bolt penetration, it is unnecessary to perform drilling at the construction site and anchor bolts protruding on the top surface of the foundation are allowed to penetrate.

The shape of the hole for anchor bolt penetration is preferably a slit shape. This makes it possible to prevent lateral displacement in the width direction at the time of installation, thereby improving the accuracy of the installation position of the airtight pressure-sensitive adhesive tape for foundation. The structure of the row 26 of holes for anchor bolt penetration is one in which a plurality of slits are arranged along a straight line at intervals that agree with the installation positions of the anchor bolts embedded in the foundation, that is, a perforated form. In one preferred embodiment, the length of one slit is in a range of from 10 mm to 50 mm, preferably from 20 mm to 40 mm, and more preferably is 30 mm. In a preferred embodiment, the interval between adjacent slits is in a range of from 3 mm to 30 mm, preferably from 5 mm to 15 mm, and more preferably is 10 mm.

The number of rows 26 of holes for anchor bolt penetration may be increased or decreased, as necessary. The number of rows 26 of holes for anchor bolt penetration may be one. However, a case where a plurality of rows 26 of holes for anchor bolt penetration are formed is preferable because a single airtight pressure-sensitive adhesive tape can deal with a plurality of sizes of sills. The number of rows 26 of holes for anchor bolt penetration is preferably in a range of from 2 to 5, and more preferably is 3.

The formation positions of the rows 26 of holes for anchor bolt penetration are positions with which the distance d, e, or f from the virtual L-shape fold line 13 to any row is substantially the same as the distance from the side surface of the sill on the exterior wall side to the installation positions of the anchor bolts. In one preferred embodiment, the distance d is 44.5 mm, the distance e is 70 mm, the distance f is 92 mm, and the distance g is 92 mm. Owing to this, the rows 26 of holes for anchor bolt penetration can be aligned with the installation positions of the anchor bolts of the sill used in correspondence to each of the 2×4 method, the 2×6 method, and the 2×8 method.

The elastic sheet 21 preferably used is one formed of an elastic resin foam. An elastic resin foam sheet is lightweight, superior in followability to irregularities on the top surface of a foundation, and superior in function of closing a gap. Examples of the elastic resin foam sheet include a closed cell foam sheet, a semi-open cell foam sheet and an open cell foam sheet, and a closed cell foam sheet is preferable. The closed cell foam sheet exhibits superior airtightness and waterproofness.

(Elastic Resin Foam Sheet)

The elastic resin foam sheet is not particularly limited, and for example, preferably has a durometer E hardness in a range of from 4 to 41. When the durometer hardness E of the elastic resin foam sheet is less than 4, the repulsive elastic force of the elastic resin foam itself is excessively low, and there is a possibility that insufficient sealability on the side surface and the bottom surface of a sill is exhibited. On the other hand, when the durometer hardness E exceeds 41, there is a possibility that insufficient followability to irregularities on the top surface of a foundation is exhibited. That is, when the durometer hardness E is out of the above range, the airtightness and waterproofness of a wooden building may be deteriorated. In addition, when the hardness of the resin elastic foam sheet is excessively high, it is difficult to fold up the fold-up portion 25 or maintain the fold-up portion in a folded state. The durometer hardness E of the elastic resin foam sheet is preferably in a range of from 8 to 30, and more preferably in a range of from 9 to 28. The durometer hardness E of the elastic resin foam sheet can be measured under the conditions defined in the JIS standard (JIS K 6253).

The elastic resin foam sheet preferably has a moisture permeability of 32 g/m²·24 h or less. When the moisture permeability of the elastic resin foam sheet exceeds 32 g/m²·24 h, the damp-proof performance of the elastic resin foam sheet is poor, so that migration of moisture released from a foundation to a sill over time cannot be sufficiently inhibited, and the sill may be gradually corroded. As a result, the airtightness and waterproofness of a wooden building may be deteriorated. It is desirable that the moisture permeability of the elastic resin foam sheet is as small as possible, and for example, the moisture permeability is preferably 16 g/²·24 h or less, and more preferably 3 g/m²·24 h or less. The moisture permeability of the elastic resin foam sheet can be measured under the conditions defined in JIS standard (JIS Z 0208:1976).

Generally, the elastic resin foam sheet 21 to be used is one manufactured by expanding an olefin-based resin or a rubber-based resin. Specifically, it is preferable to use a closed cell foam sheet manufactured by a method comprising: first preparing a foamable resin sheet by forming a foamable resin composition obtained by kneading an olefin-based resin or a rubber-based resin and a foaming agent into a sheet shape; subsequently crosslinking the foamable resin sheet with an ionizing radiation or the like; and then passing the sheet through a heating furnace to foam.

The elastic resin foam sheet suitably used for the elastic sheet 21 is not particularly limited as long as the closed cell ratio is 70% or more (for example, from 70% to 100%), but from the viewpoints of airtightness/waterproofness, elasticity and processability, a closed cell foam sheet obtained by foaming a polyolefin-based resin or a rubber-based resin is preferable, and a closed cell foam sheet obtained by foaming a polyolefin-based resin is more preferable.

The closed cell ratio is a value that serves as an index indicating the proportion of closed cells among all cells (cell structures) present in the elastic resin foam sheet. The “closed cell” refer to a cell surrounded by a wall (a wall of an elastic resin) and not interconnected to other cells. The larger the value of the closed cell ratio of the elastic resin foam sheet is, the higher the proportion of the closed cells among the cells present in the elastic resin foam sheet is. In such a case, the elastic resin foam sheet is less likely to be infiltrated with the air, or moisture and water, so that high airtightness and waterproofness can be exhibited. The closed cell ratio is preferably in a range of from 80% to 100%, and more preferably in a range of from 90% to 100%.

The method for measuring the closed cell ratio of the elastic resin foam sheet is not particularly limited, and for example, the closed cell ratio can be measured in accordance with ASTM D 2856 (1998). Specifically, first, a test piece having a planar square shape with sides of 5 cm and having a constant thickness is cut out from the elastic resin foam sheet. Then, the thickness of the test piece is measured to calculate the apparent volume V₁ (cm³) of the test piece, and the weight W₁ (g) of the test piece is also measured. Next, the apparent volume V₂ of the test piece accounted for by cells is calculated on the basis of the following formula. The density of the resin constituting the test piece is denoted by ρ (g/cm³).

Apparent volume accounted for by cells V₂=V₁−(W₁/ρ)

Subsequently, the test piece is immersed in distilled water at 23° C. to a depth of 100 mm from the water surface, and a pressure of 15 kPa is applied to the test piece for 3 minutes. Thereafter, the test piece is taken out of the water, moisture adhering to the surface of the test piece is removed, the weight W₂ (g) of the test piece is measured, and then the closed cell ratio is calculated on the basis of the following formula.

Closed cell ratio (%)=100−{100×(W₂−W₁)/V₂}

The 50% compressive stress of the elastic resin foam sheet is not particularly limited, and is preferably, for example, in a range of from 10 kPa to 200 kPa. When the 50% compressive stress of the elastic resin foam sheet is less than 10 kPa, the repulsive elastic force of the elastic resin foam itself is excessively low, and there is a possibility that insufficient sealability on the side surface and the bottom surface of a sill is exhibited. On the other hand, when the 50% compressive stress exceeds 200 kPa, there is a possibility that insufficient followability to irregularities on the top surface of a foundation is exhibited. That is, when the 50% compressive stress is out of the above range, the airtightness and waterproofness of a wooden building may be deteriorated. In addition, when the 50% compressive stress of the resin elastic foam sheet is excessively large, it may be difficult to fold up the fold-up portion 25 or maintain the fold-up portion in a folded state. The 50% compressive stress of the elastic resin foam sheet is preferably in a range of from 14 kPa to 160 kPa, and more preferably in a range of from 40 kPa to 120 kPa. The 50% compressive stress of the elastic resin foam sheet can be measured under the conditions defined in the JIS standard (JIS K 6767).

As the polyolefin-based resin to serve as a raw material resin of the closed cell foam sheet formed by foaming the polyolefin-based resin described above, a publicly known or commonly used polyolefin-based resin can be used, and is not particularly limited, and for example, one or more resins selected from among polyethylene-based resin, polypropylene-based resin, a propylene-ethylene block copolymer, an ethylene-α-olefin copolymer comprising ethylene as a main component, a propylene-α-olefin copolymer comprising propylene as a main component, an ethylene-propylene-butene terpolymer comprising propylene as a main component, polybutene and polymethylpentene are preferable. These may be used singly or two or more thereof may be used in combination. Among them, polyethylene-based resin and polypropylene-based resin are preferable as the polyolefin-based resin, and polyethylene-based resin is more preferable from the viewpoint of waterproofness.

Specifically, examples of the polyethylene-based resin include low-density polyethylene, medium-density polyethylene, high-density polyethylene, linear low-density polyethylene, an ethylene-vinyl acetate copolymer comprising ethylene as a main component and an ethylene-ethyl acrylate copolymer comprising ethylene as a main component. Among them, low-density polyethylene and high-density polyethylene are preferable from the viewpoint of improving the waterproofness, and it is preferable to use a mixture of low-density polyethylene and high-density polyethylene. Specifically, examples of the α-olefin constituting the ethylene-α-olefin copolymer include propylene, 1-butene, 1-pentene, 4-methyl-1 pentene, 1-hexene, 1-heptene and 1-octene.

As the rubber-based resin to serve as a raw material resin of the closed cell foam sheet formed by foaming the rubber-based resin described above, a publicly known or commonly used rubber-based resins can be used, and examples thereof include, but are not particularly limited to, chloroprene rubber (CR), isoprene rubber (IR), butyl rubber (IIR), natural rubber, acrylonitrile-butadiene rubber (NBR), styrene-butadiene copolymer rubber (SBR), butadiene rubber (BR), ethylene-propylene-diene rubber (EPDM), urethane rubber, fluororubber, acrylic rubber and silicone rubber. These may be used singly or two or more thereof may be used in combination. Among them, ethylene-propylene-diene rubber (EPDM) is preferable from the viewpoint of balance performance between durability and physical properties.

As the foaming agent to be used when the polyolefin-based resin or rubber-based resin is thermally foamed, a thermal decomposition type foaming agent that is decomposed by heat to generate a gas, a volatile foaming agent, or the like is suitably used. Examples of the thermal decomposition type foaming agent include azodicarbonamide, benzenesulfonyl hydrazide, dinitrosopentamethylenetetramine, toluenesulfonyl hydrazide and 4,4-oxybis(benzenesulfonylhydrazide). Examples of the volatile foaming agent include such hydrocarbons such as propane, normal butane, isobutane, normal pentane, isopentane, normal hexane and isohexane. These may be used singly or two or more thereof may be used in combination.

The blending amount of the foaming agent is preferably in a range of from 1 part by mass to 30 parts by mass, more preferably in a range of from 3 parts by mass to 25 parts by mass, and still more preferably in a range of from 5 parts by mass to 20 parts by mass based on 100 parts by mass of the elastic resin such as the polyolefin-based resin or the rubber-based resin. When the blending amount of the foaming agent is less than 1 part by mass, the expansion ratio does not increase and the apparent density increases, so that the repulsive force of the foam sheet may increase. On the other hand, when the blending amount of the foaming agent exceeds 30 parts by mass, the compression set increases due to decrease in apparent density, the shape recovery property of the foam sheet decreases, and as a result, it may be difficult to maintain airtightness and waterproofness over a long period of time.

The closed cell foam sheet may comprise an additive as necessary as long as the effects of the present invention are not impaired. Examples of the additive include a tackifier resin, a flame retardant, an antioxidant, a filler, a colorant, a pigment, an antifungal agent, a foaming aid, a lubricant, an inactivator, an antistatic agent, an ultraviolet absorber and a surfactant. When the closed cell foam is crosslinked, a crosslinking agent such as an organic peroxide, a vulcanizing agent such as sulfur or a sulfur compound, a vulcanization accelerator, or the like may be contained.

Examples of the tackifier resin include aliphatic petroleum resin (C5 petroleum resin), aromatic petroleum resin (C9 petroleum resin), aliphatic and aromatic petroleum resin (C5/C9 copolymerized petroleum resin), coumarone resin, coumarone-indene resin, pure monomer resin, dicyclopentadiene petroleum resin and tackifier resins composed of hydrides thereof.

Examples of the flame retardant include metal hydroxides such as aluminum hydroxide and magnesium hydroxide, bromine-based flame retardants such as decabromodiphenyl ether, and phosphorus-based flame retardants such as ammonium polyphosphate.

Examples of the antioxidant include phenol-based antioxidants, amine-based antioxidants, sulfur-based antioxidants and phosphorus-based antioxidants.

Examples of the filler include talc, calcium carbonate, bentonite, carbon black, fumed silica, aluminum silicate, acetylene black and aluminum powder. These additives may be used singly, or two or more thereof may be used in combination.

Examples of the colorant include black colorants such as carbon black (furnace black, channel black, acetylene black, thermal black, lamp black, etc.), graphite, copper oxide, manganese dioxide, aniline black, perylene black, titanium black, cyanine black, activated carbon, ferrite (non-magnetic ferrite, magnetic ferrite, etc.), magnetite, chromium oxide, iron oxide, molybdenum disulfide, chromium complexes, complex oxide-based black colorants and anthraquinone-based organic black colorants; inorganic white colorants such as titanium oxide (titanium dioxide such as rutile titanium dioxide and anatase titanium dioxide), zinc oxide, aluminum oxide, silicon oxide, zirconium oxide, magnesium oxide, calcium oxide, tin oxide, barium oxide, cesium oxide, yttrium oxide, magnesium carbonate, calcium carbonate (light calcium carbonate, heavy calcium carbonate, etc.), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc flower, zinc sulfide, talc, silica, alumina, clay, kaolin, titanium phosphate, mica, gypsum, white carbon, diatomaceous earth, bentonite, lithopone, zeolite, sericite and hydrated halloysite; and organic white colorants such as acrylic resin particles, polystyrene-based resin particles, polyurethane-based resin particles, amide-based resin particles, polycarbonate-based resin particles, silicone-based resin particles, urea-formalin-based resin particles and melamine-based resin particles.

The method for producing a closed cell foam sheet to be suitably used as the elastic sheet 21 of the present invention is not particularly limited, and the closed cell foam sheet can be produced by a publicly known or commonly used method. Examples thereof include (1) a method comprising: preparing a foamable resin sheet by forming into a sheet shape a foamable resin composition obtained by blending prescribed amounts of a foaming agent and, as necessary, various additives with an elastic resin of a polyolefin-based resin or a rubber-based resin and kneading them; subsequently subjecting the foamable resin sheet to crosslinking treatment by irradiation with an ionizing radiation; and then passing the sheet through a heating furnace to foam; (2) a method comprising: preparing a foamable resin sheet by forming into a sheet shape a foamable resin composition obtained by blending prescribed amounts of a foaming agent, a crosslinking agent (an organic peroxide, sulfur, a sulfur compound, or the like) and, as necessary, various additives with an elastic resin of a polyolefin-based resin or a rubber-based resin and kneading them; subsequently crosslinking and foaming the foamable resin sheet while controlling the timing of crosslinking and foaming such that a foam having a structure having a high proportion of closed cells is obtained; and (3) a method comprising: blending prescribed amounts of a surfactant and, as necessary, various additives with an elastic resin of a polyolefin-based resin or a rubber-based resin obtained by mixing linear low-density polyethylene prepared using a metallocene compound as a polymerization catalyst; feeding the blend to an extruder and melt-kneading it; then injecting a volatile foaming agent; further kneading the blend to form a resin composition for foaming; conditioning the resin composition to a foamable temperature in the extruder; extruding the resin composition through an annular die into the atmosphere; foaming the extrudate under atmospheric pressure to form a cylindrical foam; and forming the cylindrical foam into a sheet shape by cutting and opening it along the extrusion direction while expanding it in diameter with a mandrel (non-crosslinked).

Examples of a method for producing the foamable resin sheet include a method in which a foamable resin composition is kneaded using a kneading machine such as a Banbury mixer or a press kneader, and then the resin composition is continuously extruded into a sheet shape by an extruder, a calendar, conveyor belt casting, or the like.

Examples of a method for crosslinking the foamable resin sheet include crosslinking with ionizing radiation, crosslinking with an organic peroxide and crosslinking with sulfur or a sulfur compound. In the case of crosslinking with an ionizing radiation, examples of the ionizing radiation include light, y-rays and electron beams, and electron beams are suitably used. The dose of the ionizing radiation is not particularly limited, and is preferably in a range of from 0.5 Mrad to 15 Mrad, and more preferably from 0.7 Mrad to 10 Mrad.

In the case of crosslinking with an organic peroxide, examples of the organic peroxide include diisopropylbenzene hydroperoxide, 2,4-dichlorobenzoyl peroxide, benzoyl peroxide, t-butyl perbenzoate, cumyl hydroperoxide, t-butyl hydroperoxide, 1,1-di(t-butylperoxy)-3,3,5 -trimethyl hexane, n-butyl 4,4-di(t-butylperoxy)valerate, α,α′-bis(t-butylperoxyisopropyl)benzene, 2,5-dimethyl-2 5-di(t-butylperoxy)hexyne-3 and t-butyl peroxycumene. The blending amount of the organic peroxide is not particularly limited, and is preferably in a range of from 0.05 parts by mass to 10 parts by mass, and more preferably in a range of from 0.1 parts by mass to 7 parts by mass based on 100 parts by mass of the elastic resin of the polyolefin-based resin or the rubber-based resin.

Examples of the method for foaming the foamable resin sheet include a batch method in which the foamable resin sheet is foamed in an oven, and a continuous foaming method in which the foamable resin sheet is formed into an elongated sheet shape and continuously foamed through a heating furnace. The temperature at which the foamable resin sheet is foamed depends on the type of the foaming agent to be used, but is set to, for example, preferably a range of from 200° C. to 300° C., and more preferably a range of from 220° C. to 280° C.

The surface of the closed-cell foam sheet may have been subjected to a chemical or physical surface treatment such as an undercoating treatment, a corona discharge treatment, or a plasma treatment, for example, in order to improve adhesion to a pressure-sensitive adhesive layer described later.

### Pressure-Sensitive Adhesive Layer

In the airtight pressure-sensitive adhesive tape for foundation 20 of the present invention, the pressure-sensitive adhesive layer 22 is formed in a band shape, on the front surface of the elastic sheet 21, in a region extending from the side edge portion on the far side shown in FIG. 2 up to the virtual L-shape fold line 23. The band of the pressure-sensitive adhesive layer 22 is preferably parallel to the side edge portions of the elastic sheet. The band of the pressure-sensitive adhesive layer 22 may be formed in a part of the width of the above region, and a plurality of bands may be formed. The band may be formed over the entire length of the above region or may be formed intermittently. The dimensions and shape of the pressure-sensitive adhesive layer 22, e.g., the width of the band, are determined such that adhesive strength is provided which is high enough for the fold-up portion 25 of the elastic sheet 21 to be fixed during a period of time from the bonding of the fold-up portion to a side surface of a sill to the construction of the exterior wall.

The pressure-sensitive adhesive layer 22 may be arbitrarily formed from one of the side edge portions of the front surface of the elastic sheet 21 toward the other side edge portion in a partial region of a distance from one of the side edge portions to the other side edge portion. In this case, the pressure-sensitive adhesive layer may be formed in an arbitrary shape such as a dotted shape or a linear shape.

In one embodiment, the width of the pressure-sensitive adhesive layer 22 is in a range of from 5 mm to 100 mm, preferably from 10 mm to 70 mm, and more preferably from 20 mm to 60 mm. In one embodiment, the width of the pressure-sensitive adhesive layer 22 may be at least 50% of the width c of the fold-up portion 25 of the pressure-sensitive adhesive layer, for example, in a range of from 60% to 90%, or may be 100%. When there are a plurality of bands of the pressure-sensitive adhesive layer 22, the width of the pressure-sensitive adhesive layer is a value obtained by summing the widths of the bands.

The thickness of the pressure-sensitive adhesive layer is from 0.01 mm to 2.0 mm, preferably in a range of from 0.03 mm to 1.0 mm, and more preferably from 0.05 mm to 0.3 mm. When the thickness is within the above range, this is preferable because bonding performance is exhibited and warpage is less likely to occur.

The pressure-sensitive adhesive that forms the pressure-sensitive adhesive layer 22 is not particularly limited, and examples thereof include publicly known pressure-sensitive adhesives such as acrylic pressure-sensitive adhesives, rubber-based pressure-sensitive adhesives, polyester-based pressure-sensitive adhesives, urethane-based pressure-sensitive adhesives, polyamide-based pressure-sensitive adhesives, epoxy-based pressure-sensitive adhesives, vinyl alkyl ether-based pressure-sensitive adhesives, silicone-based pressure-sensitive adhesives and fluorine-based pressure-sensitive adhesives. Among them, as the pressure-sensitive adhesive of the pressure-sensitive adhesive layer 22 of the present invention, an acrylic pressure-sensitive adhesive or a rubber-based pressure-sensitive adhesive can be suitably used from the viewpoints of bondability (pressure-sensitive adhesive force) to a side surface of a sill, adhesion to the elastic sheet 21 and airtightness/waterproofness. These pressure-sensitive adhesives may be used singly or two or more kinds thereof may be used in combination. The pressure-sensitive adhesive may be a pressure-sensitive adhesive having any form, and for example, an emulsion type pressure-sensitive adhesive, a solvent type pressure-sensitive adhesive, a hot-melt type pressure-sensitive adhesive (hot-melt type pressure-sensitive adhesive), and the like can be used. From the viewpoint of pressure-sensitive adhesive properties and waterproofness, a solvent type pressure-sensitive adhesive or a hot-melt type pressure-sensitive adhesive is preferable as the form.

(Acrylic Pressure-Sensitive Adhesive)

An agent that can be used as the acrylic pressure-sensitive adhesive may be, and is not particularly limited to, a pressure-sensitive adhesive which comprises, as a base polymer, an acrylic polymer comprising an alkyl (meth)acrylate as an essential monomer component (main monomer component) and in which a copolymerizable monomer (a polar group-containing monomer, a polyfunctional monomer, or the like) copolymerizable with that alkyl (meth)acrylate is polymerized (or copolymerized), as necessary.

Examples of the alkyl (meth)acrylate (an alkyl (meth)acrylate having a linear or branched alkyl group) to be used as the main monomer component of the acrylic polymer include alkyl (meth)acrylates having an alkyl group having 1 to 24 carbon atoms such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, behenyl (meth)acrylate and tetracosyl methacrylate. These alkyl (meth)acrylates can be used singly or two or more kinds thereof may be used in combination.

Among them, from the viewpoint of bondability (pressure-sensitive adhesive force) to a side surface of a sill and airtightness/waterproofness, it is preferable to use, as the alkyl (meth)acrylate, an alkyl (meth)acrylate having an alkyl group having 1 to 7 carbon atoms and an alkyl (meth)acrylate having an alkyl group having 8 to 24 carbon atoms in combination.

Among the alkyl (meth)acrylates having an alkyl group having 1 to 7 carbon atoms, from the viewpoint of airtightness, waterproofness and versatility, alkyl (meth)acrylates having an alkyl group having 4 to 6 carbon atoms are preferable, and alkyl (meth)acrylates having an alkyl group having 4 carbon atoms are more preferable. Specifically, butyl (meth)acrylate can be suitably used.

Among the alkyl (meth)acrylates and the alkyl (meth)acrylates having an alkyl group with 8 to 24 carbon atoms, from the viewpoint of the level of balance performance of pressure-sensitive properties, alkyl (meth)acrylates having an alkyl group having 8 to 12 carbon atoms, which have low glass transition temperature, are preferable, and alkyl (meth)acrylates having an alkyl group having 8 carbon atoms are more preferable. Specifically, 2-ethylhexyl (meth)acrylate can be suitably used.

When an alkyl (meth)acrylate having an alkyl group having 1 to 7 carbon atoms and an alkyl (meth)acrylate having an alkyl group having 8 to 24 carbon atoms are used in combination as the alkyl (meth)acrylate, the mass ratio of the alkyl (meth)acrylate having an alkyl group having 1 to 7 carbon atoms to the alkyl (meth)acrylate having an alkyl group having 8 to 24 carbon atoms is preferably within a range of (alkyl (meth)acrylate having an alkyl group having 1 to 7 carbon atoms)/(alkyl (meth)acrylate having an alkyl group having 8 to 24 carbon atoms)=1/99 to 99/1, and more preferably within a range of 20/80 to 80/20.

Since the (meth)acrylate is used as the main monomer component of the acrylic polymer, the proportion of the alkyl (meth)acrylate is, for example, preferably in a range of from 70% by mass to 99.9% by mass, and more preferably in a range of from 80% by mass to 99.8% by mass based on the total amount of the monomer components for preparing the acrylic polymer.

The acrylic polymer may be copolymerized using a polar group-containing monomer as another monomer component for the purpose of improving the pressure-sensitive adhesive force of the pressure-sensitive adhesive layer 22 to a side surface of a sill or increasing cohesive force. These polar group-containing monomers may be used singly or two or more kinds thereof may be used in combination.

Examples of the polar group-containing monomer include carboxyl group-containing monomers such as (meth)acrylic acid, itaconic acid, maleic acid, fumaric acid, crotonic acid, and isocrotonic acid and anhydrides thereof (maleic anhydride and the like); hydroxy group-containing monomers such as hydroxyalkyl (meth)acrylates such as hydroxyethyl (meth)acrylate, hydroxypropyl (meth)acrylate and hydroxybutyl (meth)acrylate; amide group-containing monomers such as acrylamide, methacrylamide, N,N-dimethyl (meth)acryl amide, N-methylol(meth)acrylamide, N-methoxymethyl(meth)acrylamide and N-butoxymethyl(meth)acrylamide; amino group-containing monomers such as aminoethyl (meth)acrylate, dimethylaminoethyl (meth)acrylate and t-butylaminoethyl (meth)acryl ate; glycidyl group-containing monomers such as glycidyl (meth)acrylate and methylglycidyl (meth)acrylate; cyano group-containing monomers such as acrylonitrile and methacrylonitrile; heterocyclic ring-containing vinyl-based monomers such as N-vinylpyridine, N-vinylpiperidone, N-vinylpyrimidine, N-vinylpiperazine, N-vinylpyrrole, N-vinylimidazole and N-vinyloxazole in addition to N-vinyl-2-pyrrolidone and (meth)acryloylmorpholine; alkoxyalkyl (meth)acrylate-based monomers such as methoxyethyl (meth)acrylate and ethoxyethyl (meth)acrylate; sulfonic acid group-containing monomers such as sodium vinyl sulfonate; phosphoric acid group-containing monomers such as 2-hydroxyethylacryloyl phosphate; imide group-containing monomers such as cyclohexylmaleimide and isopropylmaleimide; and isocyanate group-containing monomers such as 2-methacryloyloxyethyl isocyanate. Among them, a carboxyl group-containing monomer such as acrylic acid or an anhydride thereof or a hydroxy group-containing monomer such as 2-hydroxyethyl acrylate is suitable as the polar group-containing monomer.

The amount of the polar group-containing monomer used is preferably in a range of from 0.1% by mass to 15% by mass, and more preferably in a range of from 0.2% by mass to 10% by mass based on the total amount of the monomer components for adjusting the acrylic polymer from the viewpoint of the balance between the pressure-sensitive adhesive force and the cohesive force of the pressure-sensitive adhesive layer 22.

The monomer component for adjusting the acrylic polymer may contain a copolymerizable monomer other than the alkyl (meth)acrylate and the polar group-containing monomer (such a copolymerizable monomer is sometimes referred to as “other copolymerizable monomer”).

Examples of the other copolymerizable monomer include (meth)acrylates having an alicyclic hydrocarbon group such as cyclopentyl (meth)acrylate, cyclohexyl (meth)acrylate and isobornyl (meth)acrylate; (meth)acrylates having an aromatic hydrocarbon group such as phenyl (meth)acrylate, phenoxyethyl (meth)acrylate and benzyl (meth)acrylate; alkoxyalkyl (meth)acrylates such as 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate and 4-ethoxybutyl (meth)acrylate; vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ethers; and vinyl chloride and the like.

The amount of the other copolymerizable monomer used is not limited as long as the effects of the present invention are not disturbed, and for example, it is preferably in a range of from 0% by mass to 15% by weight, and more preferably in a range of from 0% by mass to 10% by mass based on the total amount of the monomer components for adjusting the acrylic polymer.

When an acrylic pressure-sensitive adhesive is used for the pressure-sensitive adhesive layer 22, it is preferable to use the acrylic pressure-sensitive adhesive with addition of a tackifier resin to the acrylic polymer. Adding the tackifier resin can further enhance the pressure-sensitive adhesive force of the pressure-sensitive adhesive layer 22 to a side surface of a sill.

The tackifier resin is not particularly limited, and examples thereof include a terpene-based tackifier resin, a phenol-based tackifier resin, a rosin-based tackifier resin and a petroleum-based tackifier resin. The tackifier resins may be used singly or two or more kinds thereof may be used in combination. Among them, from the viewpoint of the balance of airtightness/waterproofness and adhesive properties, a rosin-based tackifier resin, which is superior in balance of physical properties, is preferable as the tackifier resin.

Examples of the terpene-based tackifier resin include terpene-based resins such as an α-pinene polymer, a β-pinene polymer and a dipentene polymer; and modified terpene-based resins obtained from those terpene-based resins through modification (phenol modification, aromatic modification, hydrogenation modification, hydrocarbon modification, etc.) (e.g., terpene phenol-based resins, styrene-modified terpene-based resins, aromatic modified terpene-based resins and hydrogenated terpene-based resins).

Examples of the phenol-based tackifier resin include condensates of various phenols (e.g., phenol, m-cresol, 3,5-xylenol, p-alkylphenols and resorcin) with formaldehyde (e.g., alkylphenol-based resins and xylene-formaldehyde-based resins); resols obtained by subjecting the phenols and formaldehyde to an addition reaction using an alkali catalyst; novolaks obtained by subjecting the phenols and formaldehyde to a condensation reaction using an acid catalyst; and rosin-modified phenol resins obtained through addition of phenol to rosins (unmodified rosin, modified rosin, various rosin derivatives, etc.) using an acid catalyst, followed by thermal polymerization.

Examples of the rosin-based tackifier resin include unmodified rosins such as gum rosin, wood rosin and tall oil rosin; modified rosins obtained by modifying those unmodified rosins by hydrogenation, disproportionation, polymerization, or the like (hydrogenated rosins, disproportionated rosins, polymerized rosins as well as other chemically modified rosins); and various rosin derivatives. Examples of the rosin derivatives include rosin esters such as ester compounds of rosin obtained by esterifying unmodified rosin with alcohols and ester compounds of modified rosin obtained by esterifying modified rosin such as hydrogenated rosin, disproportionated rosin and polymerized rosin with alcohols; unsaturated fatty acid-modified rosins obtained by modifying unmodified rosin or modified rosins (hydrogenated rosin, disproportionated rosin, polymerized rosin, etc.) with an unsaturated fatty acid; unsaturated fatty acid-modified rosin esters obtained by modifying rosin esters with an unsaturated fatty acid; rosin alcohols obtained by reducing carboxyl groups in unmodified rosin, modified rosins, unsaturated fatty acid-modified rosins, and unsaturated fatty acid-modified rosin esters; and metal salts of rosins (in particular, rosin esters) such as unmodified rosin, modified rosins, and various rosin derivatives.

Examples of the petroleum-based tackifier resin include petroleum resins such as aromatic petroleum resins, aliphatic petroleum resins, alicyclic petroleum resins (aliphatic cyclic petroleum resins), aliphatic-aromatic petroleum resins, aliphatic-alicyclic petroleum resins, hydrogenated petroleum resins, coumarone-based resins and coumarone-indene-based resins. Examples of the aromatic petroleum resin include polymers prepared using a single or two or more vinyl group-containing aromatic hydrocarbons having 8 to 10 carbon atoms (styrene, o-vinyltoluene, m-vinyltoluene, p-vinyltoluene, α-methylstyrene, (β-methylstyrene, indene, methylindene, etc.). Among them, aromatic petroleum resins (C9 petroleum resin) obtained from a fraction including vinyltoluene, indene or the like are preferable as the aromatic petroleum resin. Examples of the aliphatic petroleum resin include polymers prepared using a single or two or more olefins or dienes having 4 to 5 carbon atoms [olefins such as butene-1, isobutylene and pentene-1; dienes such as butadiene, piperylene (1,3-pentadiene) and isoprene]. As the aliphatic petroleum resin, aliphatic petroleum resins obtained from a fraction including butadiene, piperylene, isoprene, or the like (C4 petroleum resins, C5 petroleum resins, and the like) are preferable. Examples of the alicyclic petroleum resin include alicyclic hydrocarbon-based resins obtained by cyclizing and dimerizing the aliphatic petroleum resin and then polymerizing the resultant; polymers of cyclic diene compounds (cyclopentadiene, dicyclopentadiene, ethylidene norbornene, dipentene, ethylidene bicycloheptene, vinylcycloheptene, tetrahydroindene, vinylcyclohexene, limonene, etc.) or hydrogenated products thereof; and alicyclic hydrocarbon-based resins prepared by hydrogenating the aromatic rings of the aromatic hydrocarbon resins or the following aliphatic-aromatic petroleum resins. Examples of the aliphatic-aromatic petroleum resin include styrene-olefin-based copolymers. Examples of the aliphatic-aromatic petroleum resin include a so-called “C5/C9 copolymer-based petroleum resin”.

The addition amount of the tackifier resin is not particularly limited, and is, for example, preferably in a range of from 5 parts by mass to 60 parts by mass, and more preferably in a range of from 10 parts by mass to 50 parts by mass based on 100 parts by mass of the total amount of the acrylic polymer. When the addition amount of the tackifier resin is less than 5 parts by mass, the effect of improving the pressure-sensitive adhesive force may not be recognized. On the other hand, when the addition amount of the tackifier resin exceeds 60 parts by mass, the pressure-sensitive adhesive layer 22 becomes excessively hard and, for example, the tackiness at a low temperature decreases, the sticking property to a side surface of a sill deteriorates, and there is a possibility that the workability deteriorates or the pressure-sensitive adhesive tape peels off with time.

When an acrylic pressure-sensitive adhesive is used for the pressure-sensitive adhesive layer 22, it is preferable to use the acrylic pressure-sensitive adhesive with addition of a crosslinking agent to the acrylic polymer. Adding the crosslinking agent can enhance the cohesive force of the pressure-sensitive adhesive layer 22 and can afford a sufficient holding force with respect to a side surface of a sill. In addition, the adhesion of the pressure-sensitive adhesive layer 22 to the elastic sheet 21 can be enhanced.

The crosslinking agent is not particularly limited, and examples thereof include, an isocyanate-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an aziridine-based crosslinking agent and an amine-based crosslinking agent. The crosslinking agent can be used singly or two or more thereof may be used in combination. Among them, an isocyanate-based crosslinking agent (a polyfunctional isocyanate compound) or an epoxy-based crosslinking agent is preferable as the crosslinking agent from the viewpoint of enhancing the cohesive force of the acrylic pressure-sensitive adhesive layer 22 and improving the adhesion to the elastic sheet 21.

The isocyanate-based crosslinking agent (the polyfunctional isocyanate compound) is not particularly limited, and examples thereof include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. These may be used singly or two or more thereof may be used in combination.

Examples of the epoxy-based crosslinking agent include bisphenol A/epichlorohydrin type epoxy resins, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidyl erythritol, diglycerol polyglycidyl ether, 1,3′-bis(N,N-diglycidylaminomethyl)cyclohexane and N,N,N′,N′-tetraglycidyl-m-xylenediamine. These may be used singly or two or more thereof may be used in combination.

The addition amount of the crosslinking agent is not particularly limited, and from the viewpoint of the pressure-sensitive adhesion property, adhesion and repulsion resistance of the pressure-sensitive adhesive layer 22, the addition amount is, for example, preferably in a range of from 0.01 parts by mass to 10 parts by mass, and more preferably in a range of from 0.1 parts by mass to 5 parts by mass based on 100 parts by mass of the total amount of the acrylic polymer. When the addition amount of the crosslinking agent is less than 0.01 parts by mass, the cohesive force (holding force) of the pressure-sensitive adhesive layer 22 and the improvement in adhesion to the elastic sheet may be insufficient. On the other hand, when the addition amount of the crosslinking agent is more than 10 parts by mass, there is a possibility that the initial pressure-sensitive adhesive force is reduced or the repulsion resistance is reduced.

Furthermore, the pressure-sensitive adhesive layer 22 may contain, in addition to the acrylic polymer, the tackifier resin and the crosslinking agent, various publicly known additives such as a silane coupling agent, an anti-aging agent, a filler, a colorant (pigment, dye, etc.), an ultraviolet absorber, an antioxidant, a chain transfer agent, a plasticizer, a softening agent, a surfactant and an antistatic agent, as necessary, as long as the effects of the present invention are not impaired.

(Rubber-Based Pressure-Sensitive Adhesive)

The rubber-based pressure-sensitive adhesive is not particularly limited, and examples thereof include natural rubber-based pressure-sensitive adhesives containing natural rubber as a base polymer and synthetic rubber-based pressure-sensitive adhesives containing synthetic rubber as a base polymer. Synthetic rubber-based pressure-sensitive adhesives are preferable. Examples of the synthetic rubber in such a synthetic rubber-based pressure-sensitive adhesive include butyl rubber, polyisoprene rubber, polyisobutylene rubber, styrene-butadiene (SB) rubber, styrene-isoprene (SI) rubber, styrene-isoprene-styrene block copolymer (SIS) rubber, styrene-butadiene-styrene block copolymer (SBS) rubber, styrene-ethylene-butylene-styrene block copolymer (SEBS) rubber, styrene-ethylene-propylene-styrene block copolymer (SEPS) rubber, styrene-ethylene-propylene block copolymer (SEP) rubber, regenerated rubber and modified products thereof. Among them, butyl rubber is particularly preferable from the viewpoint of bondability (pressure-sensitive adhesive force) to a side surface of a sill, adhesion to the elastic sheet 21, airtightness/waterproofness and durability. That is, as the rubber-based pressure-sensitive adhesive, a butyl rubber-based pressure-sensitive adhesive containing butyl rubber as a base polymer can be suitably used.

The type of the butyl rubber is not particularly limited, and examples thereof include regenerated butyl rubber and synthetic butyl rubber. A single type of butyl rubber may be used, or different types of butyl rubber may be used in combination. As the butyl rubber, regenerated butyl rubber is particularly preferable from the viewpoint of processability.

When a mixture of regenerated butyl rubber and synthetic butyl rubber is used as the butyl rubber, the mass ratio of the regenerated butyl rubber to the synthetic butyl rubber is, for example, preferably in a range of (regenerated butyl rubber)/(synthetic butyl rubber)=50/50 to 99/1 from the viewpoint of processability.

The butyl rubber is used as a main component of a synthetic rubber, which is a base polymer of a synthetic rubber-based pressure-sensitive adhesive, and the ratio of the butyl rubber is, for example, preferably in a range of from 60% by mass to 100% by mass, and more preferably in a range of from 70% by mass to 100% by mass based on 100 parts by mass of the total amount of the synthetic rubber.

As the synthetic rubber, a rubber component other than the butyl rubber may be contained. Such a rubber component is not particularly limited as long as it has rubber elasticity at room temperature (23° C.), and examples thereof include polyisobutylene, acrylic rubber, silicone rubber, urethane rubber, vinyl alkyl ether rubber, polyvinyl alcohol rubber, polyvinyl pyrrolidone rubber, polyacrylamide rubber, cellulose rubber, natural rubber, butadiene rubber, chloroprene rubber, styrene-butadiene rubber, acrylonitrile-butadiene rubber, styrene-ethylene-butadiene-styrene rubber, styrene-isoprene-styrene rubber, isoprene rubber, styrene-butadiene-styrene rubber and ethylene-propylene rubber. As the rubber component other than the butyl rubber, polyisobutylene is preferable from the viewpoint of improving the cohesive force of the pressure-sensitive adhesive layer 22.

The proportion of the rubber component other than the butyl rubber is, for example, preferably in a range of from 1 part by mass to 40 parts by mass, and more preferably in a range of from 5 parts by mass to 30 parts by mass based on 100 parts by mass of the total amount of the synthetic rubber.

When a synthetic rubber-based pressure-sensitive adhesive is used for the pressure-sensitive adhesive layer 22, it is preferable to use the synthetic rubber-based pressure-sensitive adhesive with addition of a softener to the synthetic rubber. Adding a softener can impart superior pressure-sensitive adhesive properties to the pressure-sensitive adhesive layer 22 in a wide temperature range.

Examples of the softener include paraffins, waxes, naphthenes, aromatics, asphalts, drying oils (e.g., linseed oil), animal and vegetable oils, petroleum-based oils (e.g., process oil), polybutene, low molecular weight polyethylene glycol, phthalate esters, phosphate esters, stearic acid or esters thereof and alkylsulfonate esters. These may be used singly or two or more thereof may be used in combination.

The addition amount of the softener is not particularly limited, and is, for example, preferably in a range of from 10 parts by mass to 300 parts by mass, and more preferably in a range of from 20 parts by mass to 200 parts by mass based on 100 parts by mass of the total amount of the synthetic rubber (and other rubber components blended as necessary). When the addition amount of the softener is less than 10 parts by mass, the pressure-sensitive adhesive properties at a low temperature may deteriorate. On the other hand, when the addition amount of the softener exceeds 300 parts by mass, the holding property to a side surface of a sill may deteriorate.

When a synthetic rubber-based pressure-sensitive adhesive is used for the pressure-sensitive adhesive layer 22, it is preferable to use the synthetic rubber-based pressure-sensitive adhesive with addition of a tackifier resin to the synthetic rubber. Adding the tackifier resin can enhance the pressure-sensitive adhesive force of the pressure-sensitive adhesive layer 22 to a side surface of a sill or to the elastic sheet 21 can be further enhanced.

As the tackifier resin, tackifier resins the same as those recited as examples of a tackifier resin to be added to the acrylic pressure-sensitive adhesive may be used singly or two or more thereof may be used in combination. As the tackifier resin, from the viewpoint of the balance between the holding force and the pressure-sensitive adhesive force of the adhesive layer 22 and the viewpoint of compatibility with the rubber component, an aliphatic petroleum resin (C5 petroleum resin), an aromatic petroleum resin (C9 petroleum resin) and an aliphatic-aromatic petroleum resin (C5/C9 copolymer-based petroleum resin) are preferable, and an aliphatic petroleum resin (C5 petroleum resin) is more preferable.

The addition amount of the tackifier resin is not particularly limited, and is, for example, preferably in a range of from 10 parts by mass to 200 parts by mass, and more preferably in a range of from 30 parts by mass to 150 parts by mass based on 100 parts by mass of the total amount of the synthetic rubber (and other rubber components blended as necessary). When the addition amount of the tackifier resin is less than 10 parts by mass, the effect of improving the pressure-sensitive adhesive force may not be recognized. On the other hand, when the addition amount of the tackifier resin is more than 200 parts by mass, the holding property of the pressure-sensitive adhesive layer 22 deteriorates, so that the pressure-sensitive adhesive tape may peel off with time.

Furthermore, when a synthetic rubber-based pressure-sensitive adhesive is used for the pressure-sensitive adhesive layer 22, the synthetic rubber-based pressure-sensitive adhesive may be used with optional addition of a crosslinking agent or a filler to the synthetic rubber in addition to the softener and the tackifier resin.

The crosslinking agent is optionally blended in the synthetic rubber and one which can undergo crosslinked at a low temperature and, for example, has a relatively high crosslinking rate is used. Specifically, examples thereof include a quinoid compound, a thiuram compound, a quinone dioxime compound and a maleimide compound. Adding the crosslinking agent can enhance the cohesive force of the pressure-sensitive adhesive layer 22 and can afford a further sufficient holding force with respect to a side surface of a sill.

Examples of the quinoid compound include poly-p-dinitrosobenzene. Examples of the thiuram compound include tetramethylthiuram disulfide, tetraethylthiuram disulfide, tetrabutylthiuram disulfide, tetrakis(2-ethylhexyl)thiuram disulfide, dipentamethylenethiuram tetrasulfide and tetramethylthiuram monosulfide. Examples of the quinone dioxime compound include p-quinone dioxime and p,p′-dibenzoylquinone dioxime. Examples of the maleimide compound include N,N′-m-phenylenedimaleimide, N,N′-p-phenylenedimaleimide and N,N′-ethylenedimaleimide. These may be used singly or two or more thereof may be used in combination. Among them, a quinoid compound or a quinone dioxime compound is preferable as the crosslinking agent.

The addition amount of the crosslinking agent is not particularly limited, and is, for example, preferably in a range of from 0.05 parts by mass to 10 parts by mass, and more preferably in a range of from 0.06 parts by mass to 1 part by mass based on 100 parts by mass of the total amount of the synthetic rubber (and other rubber components blended as necessary). When the addition amount of the crosslinking agent is within the above range, the effect of improving the cohesive force by crosslinking can be sufficiently achieved in the pressure-sensitive adhesive layer 22, and the followability to irregularities can also be maintained.

The filler is optionally blended in the synthetic rubber, and examples thereof include calcium carbonate (heavy calcium carbonate or light calcium carbonate), talc, titanium oxide, carbon black, silica and magnesium oxide. Adding the filler can reinforce the pressure-sensitive adhesive layer 22 and can afford a further sufficient holding force with respect to a side surface of a sill. These may be used singly or two or more thereof may be used in combination. Among them, calcium carbonate is preferable as the filler.

The addition amount of the filler is not particularly limited, and is, for example, preferably in a range of from 50 parts by mass to 400 parts by mass, and more preferably in a range of from 150 parts by mass to 300 parts by mass based on 100 parts by mass of the total amount of the synthetic rubber (and other rubber components blended as necessary). When the addition amount of the filler is within the above range, the reinforcing effect can be sufficiently achieved in the pressure-sensitive adhesive layer 22.

Furthermore, when a synthetic rubber-based pressure-sensitive adhesive is used for the pressure-sensitive adhesive layer 22, additives such as an anti-aging agent, a flame retardant, a crosslinking aid, a processing aid and a lubricant may be added to the synthetic rubber as necessary as long as the effects of the present invention are not impaired.

The methods for producing the acrylic pressure-sensitive adhesive and the rubber-based pressure-sensitive adhesive described above are not particularly limited, and publicly known or commonly used methods can be used. For example, the acrylic pressure-sensitive adhesive described above can be obtained by a method in which an acrylic polymer, a tackifier resin, a crosslinking agent, and as necessary, a solvent and other additives are blended in a prescribed ratio and mixed in a tank, or the like, and the rubber-based pressure-sensitive adhesive can be obtained by a method in which a rubber-based component, a softener, a tackifier resin, and as necessary, a crosslinking agent, a filler, an anti-aging agent and other additives are blended in a prescribed ratio, and heated and kneaded using a kneading machine (kneader, twin-screw kneader, etc.) or the like.

### Method for Manufacturing Airtight Pressure-Sensitive Adhesive tape for Foundation

The airtight pressure-sensitive adhesive tape for foundation 20 of the present invention can be manufactured by forming the above-described pressure-sensitive adhesive layer 22 in a band shape on the front surface of the elastic sheet 21, in a region extending from the side edge portion on the far side shown in FIG. 2 up to the virtual L-shape fold line 23 (corresponding to the fold-up portion 25).

The method for forming the pressure-sensitive adhesive layer 22 in the region of the fold-up portion 25 of the elastic sheet 21 is not particularly limited, and examples thereof include: (1) a method in which the above-described pressure-sensitive adhesive is applied to a peeling-treated surface of a first release sheet by a publicly known or commonly used method to form a pressure-sensitive adhesive layer 22, a “double-side pressure-sensitive adhesive tape without a substrate material” is prepared by bonding a peeling-treated surface of a second release sheet to a surface of the pressure-sensitive adhesive layer 22 opposite from the surface in contact with the first release sheet, and cut into a prescribed width, then a release sheet on a light-release side is peeled, and the exposed surface of the pressure-sensitive adhesive layer 22 is bonded to a region of the fold-up portion 25 of the elastic sheet 21, and thereby the pressure-sensitive adhesive layer 22 is formed in the region of the fold-up portion 25 of the elastic sheet 21; (2) a method in which the above-described pressure-sensitive adhesive layer is directly applied or transferred by a publicly known or commonly used method to both surfaces of a substrate material such as cloth (cotton fabric, staple fiber fabric, nonwoven fabric, etc.), paper (Japanese paper, kraft paper, etc.), plastics (cellophane, polyethylene, polyester, polyvinyl chloride, polypropylene, polyethylene terephthalate, polystyrene, polyacrylonitrile, etc.), metal foil, or a plastic laminate thereof to form a first pressure-sensitive adhesive layer 22 and a second pressure-sensitive adhesive layer 22′, a “double-sided pressure-sensitive adhesive tape with a substrate material” having a double-sided peeling-treated release sheet provided thereon is prepared and cut into a prescribed width, then a surface of the second pressure-sensitive adhesive layer 22′ is bonded to a region of the fold-up portion 25 of the elastic sheet 21, and thereby the pressure-sensitive adhesive layer 22 is formed in a region of the fold-up portion 25 of the elastic sheet 21; and (3) a method in which the above-described pressure-sensitive adhesive is applied directly to a region of the fold-up portion 25 of the elastic sheet 21, and thereby a pressure-sensitive adhesive layer 22 is formed in a region of the fold-up portion 25 of the elastic sheet 21.

The band of the pressure-sensitive adhesive layer 22 is preferably formed in the entire region of the fold-up portion 25, but may be formed in a part of the width of the region, a plurality of bands may be formed, or the bands may be intermittently formed in the entire length of the region. In this case, the pressure-sensitive adhesive layer 22 of the double-sided pressure-sensitive adhesive tape may be formed according to the band-like form of the pressure-sensitive adhesive layer 22 to be finally adopted in the method for forming the pressure-sensitive adhesive layer 22. That is, the pressure-sensitive adhesive layer 22 may be formed by, for example, stripe coating, intermittent coating, or the like. The pressure-sensitive adhesive force of the pressure-sensitive adhesive layer 22 to an SPF material at 23° C. is preferably 1 N/10 mm to 10 N/mm, and more preferably 2 N/10 mm to 8 N/mm.

### Airtight Damp-Proofing Method for Wooden Building

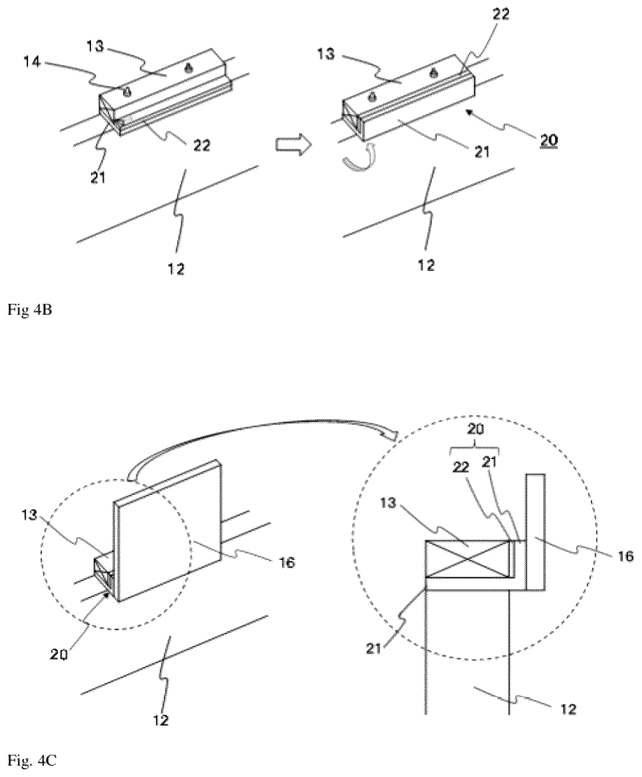

The airtight pressure-sensitive adhesive tape for foundation 20 of the present invention is used for sealing a gap between a foundation 12 and a sill 13 so that outside air does not enter an underfloor space in airtight damp-proofing construction around a foundation of a wooden building. An airtight damp-proofing method for a wooden building using the airtight pressure-sensitive adhesive tape for foundation 20 of the present invention will be described with reference to simplified FIGS. 4A to 4C. First, as illustrated in FIG. 4A, the elastic sheet 21 of the airtight pressure-sensitive adhesive tape is disposed between the top surface of the foundation 12 and the bottom surface of the sill 13 such that the portion of the front surface of the elastic sheet 21 from the side edge portion on the side where the pressure-sensitive adhesive layer 22 is not formed to the virtual L-shape fold line 23, namely, the underlay portion 24 of the surface of the elastic sheet 21 comes into contact with the bottom surface of the sill 13 and the virtual L-shape fold line 23 coincides with the end portion on the exterior wall side of the sill 13.

Since the elastic sheet 21 is superior in followability to irregularities on the top surface of the foundation 12 and is superior in a function of sealing a gap, the elastic sheet 21 is not required to have a pressure-sensitive adhesive layer on the bottom surface, and it is also not necessary to apply a sealant or an adhesive to the top surface of the foundation 12. As a result, the elastic sheet 21 is not bonded to the top surface of the foundation 12, and the installation position can be easily adjusted after once installed.

When the airtight pressure-sensitive adhesive tape for foundation 20 is provided with a row 26 of holes for anchor bolt penetration in advance in the underlay portion 24 of the elastic sheet 21, the airtight pressure-sensitive adhesive tape for foundation 20 can be unfolded and installed while anchor bolts 14 embedded in the foundation 12 and protruding on the top surface of the foundation 12 are easily made to penetrate. That is, a labor that a worker forms on site holes for allowing anchor bolts to penetrate is eliminated and a worker can efficiently install the airtight pressure-sensitive adhesive tape for foundation 20 on the top surface of the foundation 12 without unnecessarily damaging the elastic sheet 21 of the airtight pressure-sensitive adhesive tape for foundation 20. Therefore, any worker can install the airtight pressure-sensitive adhesive tape for foundation 20 on the top surface of the foundation 12 always in a stable state.

Next, as illustrated in FIG. 4B, the sill 13 is installed on the surface of the underlay portion 24 of the airtight pressure-sensitive adhesive tape for foundation 20 installed on the top surface of the foundation 12 with penetration by the anchor bolts 14, and is tightened and fixed with nuts. Then, a portion of the elastic sheet 21 extending from the side edge portion located on a side where the pressure-sensitive adhesive layer 22 is formed to the virtual L-shape fold line 23, that is, the fold-up portion 25 is folded up along the virtual L-shape fold line 23 in a direction in which the pressure-sensitive adhesive layer 22 faces inward, and the pressure-sensitive adhesive layer 22 is bonded to the side surface of the sill 13 while the release sheet on the surface of the pressure-sensitive adhesive layer 22 is peeled off. Since the fold-up portion 25 of the elastic sheet 21 is fixed for a period from when it is bonded to the side surface of the sill 13 to when the exterior wall is constructed, the work of constructing the exterior wall is simplified.

The pressure-sensitive adhesive force and the holding force of the pressure-sensitive adhesive layer 22 of the airtight pressure-sensitive adhesive tape for foundation 20 are not particularly limited as long as the fold-up portion 25 of the elastic sheet 21 bonded to the side surface of the sill 13 does not peel off during a period until the exterior wall is constructed, and for example, the pressure-sensitive adhesive force to SUS in a 180° peel test (tensile speed: 300 mm/min) is preferably 4 N/10 mm or more, and more preferably 5 N/10 mm or more. The holding force (static load: 9.8 N, sticking area: 25 mm×25 mm) at 40° C. is preferably a fall time of 500 minutes or more, and it is more preferable that the airtight pressure-sensitive adhesive tape does not fall for 24 hours.

Next, as illustrated in FIG. 4C, the exterior wall 16 is installed such that it comes into contact with the elastic sheet 21 of the airtight pressure-sensitive adhesive tape for foundation 20 bonded on the side surface of the sill 13. Since the member bonded to the side surface of the sill 13 is the thick elastic sheet 21 and has a structure folded up in an L shape, wrinkles are less likely to be formed, and the elastic sheet 21 does not float off the side surface of the sill 13, which is an adherend surface. As a result, any worker can seal a gap between the sill 13 and the exterior wall 16 always at a high level and superior airtightness is provided.

As such, in the airtight damp-proofing method using the airtight pressure-sensitive adhesive tape for foundation 20 of the present invention, it is not necessary to apply a sealant, a pressure-sensitive adhesive, a sealing tape, or the like on the top surface of a foundation 12, and it is not necessary to apply a sealant or a sealing tape that straddles the surface of an exterior wall 16 and the side surface of the foundation 12, and it is possible to always seal two gaps, that is, a gap between a sill 13 and the foundation 12 and a gap between the sill 13 and the exterior wall 16, at a high level with a small number of man-hours without being affected by the ability of workers.

The airtight pressure-sensitive adhesive tape for foundation of the present invention is used by being installed, for example, between the foundation 12 and the sill 13 and between the sill 13 and the exterior wall 16 of a wooden building. As a result, the gap between the foundation and the sill of the building and the gap between the exterior wall and the side surface are sealed, and the outside hot air/cold air is prevented from entering the room. That is, by use of the airtight pressure-sensitive adhesive tape for foundation of the present invention, a building having high airtightness can be realized.

### EXAMPLES

### Embodiments 1 to 6

Preparation of Airtight Pressure-Sensitive Adhesive Tape

First, commercially available resin foam sheets A to F as shown in Tables 1 and 2 were prepared as the elastic sheet 21 to be used in the airtight pressure-sensitive adhesive tape for foundation 20 of Embodiment 1 to 6. In Tables 1 and 2, EPDM means ethylene-propylene-diene rubber, PE means polyethylene, and hardness means durometer E hardness.

TABLE 1

| Resin foam sheet | A | B | C | D |
|---|---|---|---|---|
| Trade name | Tough-Long ES | Minafoam #150 | Toraypef 30050 AG00 | SUNPELCA L-2500 |
| Manufacturer | Okayasu Rubber Co., | Sakai Chemical | Toray Industries, Inc. | Sanwa Kako Co., Ltd. |
| | Ltd. | Industry Co., Ltd. | | |
| Material | EPDM | PE | PE | PE |
| Cell type | Closed cell | Closed cell | Closed cell | Closed cell |
| Thickness (mm) | 5 | 5 | 5 | 5 |
| Hardness | 9.2 | 21.9 | 27.9 | 24.6 |
| 50% Compressive | 100 | 90 | 120 | 115 |
| stress (kPa) | | | | |
| Moisture permeability | 12.1 | 24.8 | 5.0 | 9.4 |
| (g/m² · 24 h) | | | | |

TABLE 2

| Resin foam sheet | E | F |
|---|---|---|
| Trade name | SUNPELCA L-2000 | OPCELL LC-150 |
| Manufacturer | Sanwa Kako Co., Ltd. | Sanwa Kako Co., Ltd. |
| Material | PE | PE |
| Cell type | Closed cell | Open cell |
| Thickness (mm) | 5 | 5 |
| Hardness | 41.0 | 4.9 |
| 50% Compressive | 160 | 14 |
| stress (kPa) | | |
| Moisture permeability | 20.1 | — |
| (g/mm² · h) | | |

Subsequently, on the regions of the fold-up portions of six types of resin foam sheets A to F, pressure-sensitive adhesive layers were formed using three types of pressure-sensitive adhesives, namely, an acrylic pressure-sensitive adhesive, a butyl rubber-based pressure-sensitive adhesive, and a styrene-isoprene-styrene block copolymer (SIS) rubber-based pressure-sensitive adhesive. The formation of pressure-sensitive adhesive layers was carried out by a method in which the below-listed three types of “double-sided pressure-sensitive adhesive tape with a substrate material” differing in the type of pressure-sensitive adhesive are prepared and the double-sided pressure-sensitive adhesive tapes are stuck to the regions of the fold-up portions of the respective resin foam sheets.
(a) No. 5487 Double coated paper tape (nonwoven fabric substrate material) (trade name) manufactured by Maxell, Ltd.
   Pressure-sensitive adhesive: acrylic pressure-sensitive adhesive
   Substrate material: rayon fiber/wood pulp-based nonwoven fabric (basis weight: 13 g/m²)
   Overall tape thickness: 0.12 mm (excluding release sheet)
   Pressure-sensitive adhesive force to SUS: 6.0 N/10 mm (180° peeling test)
   Holding force: amount of creep 0.3 mm (40° C., 9.8 N static load)
(b) No. 5938 Super butyl tape (Double sided) (trade name) manufactured by Maxell, Ltd.
   Pressure-sensitive adhesive: butyl rubber-based pressure-sensitive adhesive
   Base: polyethylene-based nonwoven fabric [CLAF (trademark)] (basis weight: 23 g/m²)
   Overall tape thickness: 0.50 mm (excluding release sheet)
   Pressure-sensitive adhesive force to SUS: 7.8 N/10 mm (180° peeling test)
(c) No. 5422 Double coated paper tape (nonwoven fabric substrate material) (trade name) manufactured by Maxell, Ltd.
   Pressure-sensitive adhesive: styrene-isoprene-styrene block copolymer (SIS) rubber-based pressure-sensitive adhesive
   Substrate material: rayon fiber/wood pulp-based nonwoven fabric (basis weight: 13 g/m²)
   Overall tape thickness: 0.13 mm (excluding release sheet)
   Pressure-sensitive adhesive force to SUS: 16.1 N/10 mm (180° peeling test)
   Holding force: Drop time 600 minutes (40° C., 9.8 N static load)

Specifically, first, the resin foam sheets were each cut, affording elastic sheets for test having a width of 125 mm and a length of 25 mm. Subsequently, the double-sided pressure-sensitive adhesive tapes were cut and the double-sided adhesive tapes were each stuck to a region up to 40 mm from a side edge portion in the width direction of the elastic sheet for test. Thus, airtight pressure-sensitive adhesive tapes for test 20 of Embodiments 1-(a), -(b) -(c) to Embodiments 6-(a), -(b) and -(c), which are each composed of an underlay portion 85 mm long in the width direction and a fold-up portion 40 mm long in the width direction and differ in the type of pressure-sensitive adhesive, were obtained. The configurations are shown in Tables 3 and 4.

TABLE 3

| | | Embodiments | Embodiments | Embodiments | Embodiments |
|---|---|---|---|---|---|
| | | 1-(a) | 2-(a) | 3-(a) | 4-(a) |
| | | to 1-(c) | to 2-(c) | to 3-(c) | to 4-(c) |
| Resin foam | Type | A | B | C | D |
| sheet | Cell type | Closed cell | Closed cell | Closed cell | Closed cell |
| | Thickness (mm) | 5 | 5 | 5 | 5 |
| | Hardness | 9.2 | 21.9 | 27.9 | 24.6 |
| | 50% Compressive | 100 | 90 | 120 | 115 |
| | stress (kPa) | | | | |
| | Moisture | 12.1 | 24.8 | 5.0 | 9.4 |
| | permeability | | | | |
| | (g/m² · 24 h) | | | | |
| Pressure- | Embodiment-(a) | Acrylic | Acrylic | Acrylic | Acrylic |
| sensitive | Embodiment-(b) | Butyl rubber-based | Butyl rubber-based | Butyl rubber-based | Butyl rubber-based |
| adhesive | Embodiment-(c) | SIS rubber-based | SIS rubber-based | SIS rubber-based | SIS rubber-based |
| layer | | | | | |

TABLE 4

| | | Embodiments | Embodiments |
|---|---|---|---|
| | | 5-(a) to 5-(c) | 6-(a) to 6-(c) |
| Resin foam sheet | Type | E | F |
| | Cell type | Closed cell | Open cell |
| | Thickness (mm) | 5 | 5 |
| | Hardness | 41.0 | 4.9 |
| | 50% Compressive stress (kPa) | 160 | 14 |
| | Moisture permeability | 20.1 | — |
| | (g/m² · 24 h) | | |
| Pressure-sensitive | Embodiment-(a) | Acrylic | Acrylic |
| adhesive layer | Embodiment-(b) | Butyl rubber-based | Butyl rubber-based |
| | Embodiment-(c) | SIS rubber-based | SIS rubber-based |

For the airtight pressure-sensitive adhesive tapes 20 of Embodiment 1 to 6, the following airtightness test and peeling property test with respect to an SPF material were performed.

Airtightness Test

Generally, a top surface of a foundation 12 has 1 to 2 mm irregularities. As a result of the airtightness test described below, the resin foam sheets A to F used in the airtight pressure-sensitive adhesive tapes of Embodiments 1 to 6 were confirmed as being capable of sealing a gap with the bottom surface of the sill, where the gap was caused by the irregularities on the top surface of the foundation 12.

(Preparation of Testing Body)

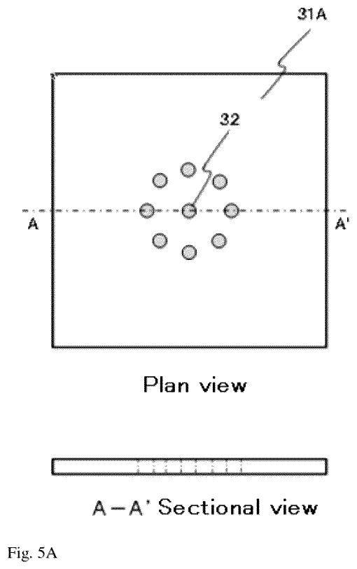

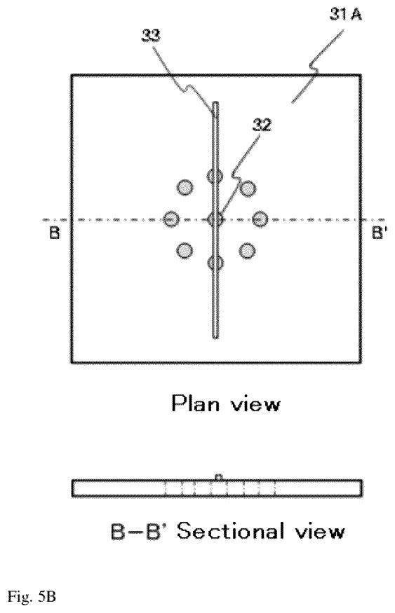

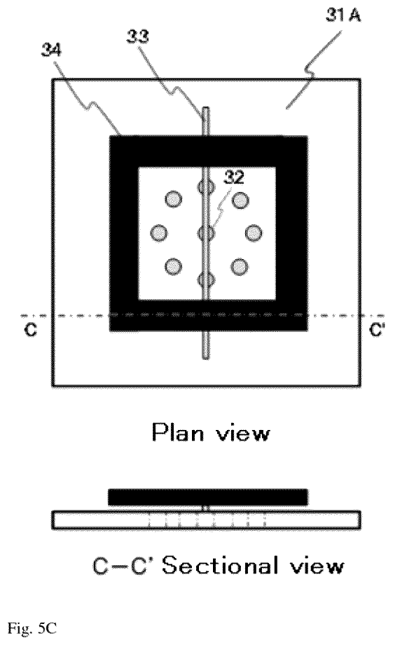

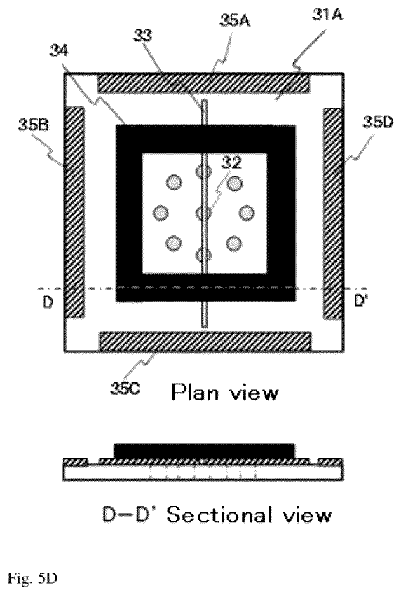

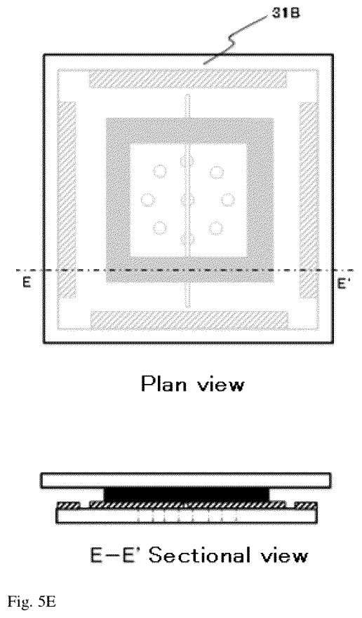

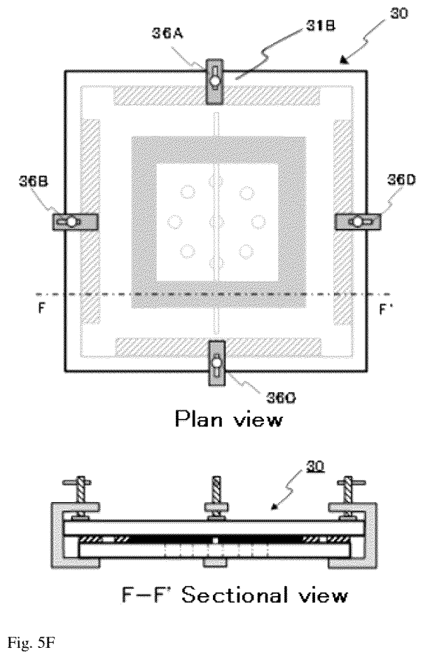

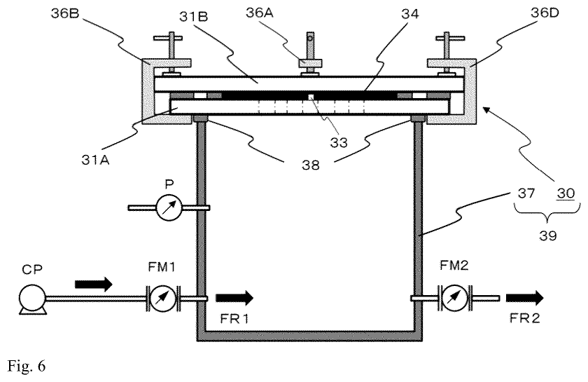

Test bodies to be subjected to the airtightness test were prepared by the following method. First, two stainless steel plates 31A (thickness: 4 mm) and 31B (thickness: 6 mm) were prepared. As illustrated in FIG. 5A, the stainless steel plate 31A is provided with nine holes including a center hole 32 having a diameter of 10 mm at a central portion of the plate. The upper part of FIGS. 5A to 5C is a plan view when viewed from directly above, and the lower part is a cross-sectional view corresponding thereto. As illustrated in FIG. 6, the stainless steel plate 31A is placed on the four top sides of the acrylic container 37 formed of five faces (a bottom face and four side faces) having no top face portion. Here, a sealing material 38 has been applied to the four top sides of the acrylic container 37, whereby the stainless steel plate 31 A and the four top sides of the acrylic container are sealed such that the air is not allowed to leak. Next, as illustrated in FIG. 5B, one acrylic bar 33 being 2 mm square in cross section is placed on the stainless steel plate 31A. In the FIG. 5B and the following, the stainless steel plate 31A is actually placed sealingly on the acrylic container 37, but the acrylic container 37 is not depicted for convenience in the cross-sectional views. Next, as illustrated in FIG. 5C, a resin foam sheet 34 cut into a square ring shape is placed on the acrylic bar 33 so as to straddle the acrylic bar 33. Further, as illustrated in FIG. 5D, spacers 35A, 35B, 35C and 35D (thickness: a thickness corresponding to that at 50% compression of the resin foam sheet; for example, when the resin foam sheet has a thickness of 5 mm, the thickness of the spacers is 2.5 mm) are respectively placed around the four sides of the stainless steel plate 31A. Next, as illustrated in FIG. 5E, another stainless steel plate 31B having no holes is stacked on the resin foam sheet 34. Finally, as illustrated in FIG. 5F, the two stainless steel plates 31A and 31B were pressed using four clamps 36A, 36B, 36C and 36D until the interval reached the thickness of the spacers (2.5 mm), affording a test body 30 to be subjected to the airtightness test. The test body 30 is configured assuming a state in which the underlay portion 24 of the resin foam sheet of the airtight pressure-sensitive adhesive tape for foundation 20 of the present invention is placed on the top surface of a foundation having a projection having a height of 2 mm and a thickness of 2 mm that stands 2 mm perpendicularly on a plane (the foundation corresponds to the stainless steel plate 31A on which the acrylic bar 32 is placed), and a sill 13 (corresponding to the stainless steel plate 31B) is placed thereon, and these members are fixed with anchor bolts (corresponding to the clamps 36). At the same time, a test body assuming a state where the acrylic bar 33 was not placed, that is, a test body assuming the top surface of a foundation having no projection was also prepared in the same manner, and subjected to the airtightness test.

(Evaluation of Airtightness)

As illustrated in FIG. 6, the airtightness test of the resin foam sheet used in the airtight pressure-sensitive adhesive tape for foundation 20 (the resin foam sheet 34 cut into a square ring shape in the test body 30) was performed using an airtight container (chamber) 39 having an inner volume of about 8 liters that is composed of the acrylic container 37 and the test body 30 placed sealingly thereon as a top plate. The airtight container 39 is provided with an air inlet and an air outlet, which include an inlet-side flowmeter FM1 and an outlet-side flowmeter FM2, respectively, and further provided with a differential pressure gauge P that measures a differential pressure in the airtight container. The airtightness test was performed by measuring, with the outlet-side flowmeter FM2, the flow rate FR2 of the air discharged from the outlet side of the airtight container 39 when the air having a constant flow rate FR1 (for example, 100 ml/min) controlled by the inlet-side flowmeter FM1 was fed through the inlet of the airtight container 39 using a compressor CP, and calculating a value of the ratio (FR2/FR1)×100 (%). That is, the higher the ratio, the more superior the airtightness. The value of airtightness is not particularly limited, and is, for example, preferably 88.0% or more, more preferably 99.0% or more, and particularly preferably 99.5% or more when measured in a state where the resin foam sheet is compressed by 50%. The fact that the airtightness value of the airtight pressure-sensitive adhesive tape for foundation 20 is large means that the airtight pressure-sensitive adhesive tape is superior in the performance of insulating a building.

In Table 5 are shown the evaluation results of the airtightness test of the six types of resin foam sheets A to F (in the test bodies 30, the resin foam sheets 34 cut into a square ring shape) used in the airtight pressure-sensitive adhesive tapes for foundation 20 of Embodiments 1 to 6.

TABLE 5

| | | Embodiment | Embodiment | Embodiment | Embodiment | Embodiment | Embodiment |
|---|---|---|---|---|---|---|---|
| | | 1 | 2 | 3 | 4 | 5 | 6 |
| Resin foam sheet | | A | B | C | D | E | F |
| Airtightness | No acrylic bar | 99.9 | 99.9 | 100.0 | 99.8 | 99.7 | 96.3 |
| (%) | (no 2 mm | | | | | | |
| | projection) | | | | | | |
| | With acrylic bar | 99.9 | 99.7 | 99.3 | 99.8 | 88.0 | 90.4 |
| | (with 2 mm | | | | | | |
| | projection) | | | | | | |

As shown in Tables 4 and 5, the airtightness of the six types of resin foam sheets A to F used in the airtight pressure-sensitive adhesive tapes for foundation 20 of Embodiment 1 to 6 (in the test body 30, the resin foam sheets 34 cut into a square ring shape) was a high value in a range of 96.3% to 100.0% in the case of no acrylic bar (no 2 mm projection), and a high value in a range of 88.0 to 99.9% even in the case with an acrylic bar (with 2 mm projection). That is, it was confirmed that the gap between the stainless steel plate 31A having a 2 mm high projection 33 formed of an acrylic bar (assuming the top surface of the foundation 12) and the stainless steel plate 31B having only a plane portion (assuming the bottom surface of the sill 13) is sealed in a highly airtight state by placing the underlay portion 24 in the resin foam sheet used in the airtight pressure-sensitive adhesive tape for foundation 20 and compressing it. In addition, even in a case where there was no 2 mm high projection 33, it was confirmed that sealing was similarly attained in an extremely highly airtight state. Among these embodiments, especially for the resin foam sheets A to D used in the airtight pressure-sensitive adhesive tapes for foundation 20 of Embodiments 1 to 4, it was confirmed that sealing was attained in an extremely highly airtight state regardless of the presence or absence of a projection on the top surface of the foundation 12.

(Peeling Property Test With Respect to SPF Material)

Two SPF materials having a height of 2 inches, a width of 4 inches, and a length of 30 inches for use as a sill were prepared. The two SPF materials were stacked, and an airtight pressure-sensitive adhesive tape for test was disposed between the two SPF materials such that the underlay portion 24 was sandwiched and the fold-up portion 25 was protruded, and two 2 kg weights were placed so that the upper SPF material was not lifted. The fold-up portion 25 of the elastic sheet 21 of the airtight pressure-sensitive adhesive tape for test 20 was folded in a direction in which the pressure-sensitive adhesive layer 22 faced inward, and attached to the side surface of the SPF material, and then pressure-bonded using a roller having a weight of 2 kg.

Under the environments of 0° C. and 40° C., the duration of a state in which the fold-up portion 25 of the elastic sheet 21 of the airtight pressure-sensitive adhesive tape for test 20 of Embodiments 1-(a), -(b) and -(c) to Embodiments 6-(a), -(b) and -(c) was bonded to the side surface of the SPF material was measured. For all the airtight pressure-sensitive adhesive tapes for test 20, it was confirmed that the bonded state was maintained without peeling of the fold-up portion 25 of the airtight pressure-sensitive adhesive tape 20 from the SPF material for at least 336 hours after the bonding was started under any environment.

### Embodiments 7 to 9

<Airtightness test>

As the elastic sheets 21 of the airtight pressure-sensitive adhesive tapes 20 of Embodiments 7 to 9, commercially available resin foam sheets G to I shown in Table 6 were prepared.

TABLE 6

| Resin foam sheet | G | H | I |
|---|---|---|---|
| Trade name | OPCELL LC-300#1 | SUNPELCA L-1500 | SUNPELCA L-1400 |
| Manufacturer | Sanwa Kako Co., Ltd. | Sanwa Kako Co., Ltd. | Sanwa Kako Co., Ltd. |
| Material | PE | PE | PE |
| Cell type | Open cell | Closed cell | Closed cell |
| Thickness (mm) | 5 | 5 | 5 |
| Hardness | 1.5 | 50.0 | 55.7 |
| 50% Compressive stress | 5 | 210 | 220 |
| (kPa) | | | |
| Moisture permeability | — | 7.12 | 9.27 |
| (g/m² · 24 h) | | | |

Airtightness was evaluated in the same manner as in Embodiments 1 to 6 except that these resin foam sheets were used instead of the resin foam sheets A to F shown in Tables 1 and 2. The results of the evaluation are shown in Table 7.

TABLE 7

| | | Embodiment | Embodiment | Embodiment |
|---|---|---|---|---|
| | | 7 | 8 | 9 |
| Resin foam sheet | | G | H | I |
| Airtightness | No acrylic bar | 98.7 | 99.7 | 99.7 |
| (%) | (no 2 mm | | | |
| | projection) | | | |
| | With acrylic bar | 71.5 | 76.1 | 67.0 |
| | (with 2 mm | | | |
| | projection) | | | |

<Preparation of Airtight Pressure-Sensitive Adhesive Tape>

Airtight pressure-sensitive adhesive tapes 20 can be manufactured in the same manner as in Embodiments 1 to 6 except that resin foam sheets G to I shown in Table 6 are used instead of the resin foam sheets A to F shown in Tables 1 and 2. The airtight pressure-sensitive adhesive tapes 20 to be manufactured are maintained in a bonded state for a period from when the airtight pressure-sensitive adhesive tape is bonded to a side surface of a sill 13 to when an exterior wall is constructed.

Reference Signs List
11 Ground surface
12 Foundation
13 Sill
14 Anchor bolt
15 Column
16 Exterior wall
17 Floor
20 Airtight pressure-sensitive adhesive tape for foundation
21 Elastic sheet
22 Pressure-sensitive adhesive layer
23 Virtual L-shape fold line
24 Underlay portion
25 Fold-up portion
26 Row of holes for anchor bolt penetration
30 Test body (Top plate)
31A, 31B Stainless steel plate
32 Hole
33 Acrylic bar
34 Resin foam sheet cut into square ring shape
35 Spacer
36A, 36B, 36C, 36D Clamp
37 Acrylic container
38 Sealing material
39 Airtight container (chamber)
CP Compressor
FM1 Inlet-side flowmeter
FM2 Outlet-side flowmeter
P Differential pressure gauge

What is claimed is:

1. An airtight pressure-sensitive adhesive tape for foundation having:
a band-shaped airtight elastic sheet having a front surface, a back surface and two side edge portions opposing each other, and
a portion having a pressure-sensitive adhesive layer and a portion having no pressure-sensitive adhesive layer on the elastic sheet; and having
a pressure-sensitive adhesive layer extending from one of the side edge portions of the elastic sheet toward the other side edge portion in a partial region of a distance from one of the side edge portions to the other side edge portion.

2. The airtight pressure-sensitive adhesive tape for foundation according to claim 1, wherein a distance of the portion having no pressure-sensitive adhesive layer located between one of the side edge portions and the other side edge portion is substantially the same as a width of the sill.

3. The airtight pressure-sensitive adhesive tape for foundation according to claim 1, wherein a distance of the portion having no pressure-sensitive adhesive layer located between one of the side edge portions and the other side edge portion is from 90 mm to 410 mm.

4. The airtight pressure-sensitive adhesive tape for foundation according to claim 1, wherein the airtight pressure-sensitive adhesive tape has a row of a plurality of holes for anchor bolt penetration, the holes being formed in a region extending from a side edge portion of the elastic sheet on a side where no pressure-sensitive adhesive layer is formed before the pressure-sensitive adhesive layer and being aligned parallel to the side edge portion at regulated intervals, the holes for anchor bolt penetration having a slit shape.

5. The airtight pressure-sensitive adhesive tape for foundation according to claim 1, having 1 to 5 rows of the row of holes for anchor bolt penetration.

6. The airtight pressure-sensitive adhesive tape for foundation according to claim 1, wherein the elastic sheet is formed of an elastic resin foam.

7. An airtight pressure-sensitive adhesive tape for foundation having:
a band-shaped airtight elastic sheet having a front surface, a back surface and two parallel side edge portions opposing each other,
a virtual L-shape fold line that is parallel to the side edge portions of the elastic sheet and is located away from one of the side edge portions of the elastic sheet toward the inside of the elastic sheet, and
a band-shaped pressure-sensitive adhesive layer that is parallel to the side edge portions of the elastic sheet and is formed in a region of the front surface of the elastic sheet extending from one of the side edge portions up to the virtual L-shape fold line, and having
no pressure-sensitive adhesive layer on other regions of the front surface and the back surface of the elastic sheet,
the airtight pressure-sensitive adhesive tape being foldable into an L shape along the virtual L-shape fold line.

8. The airtight pressure-sensitive adhesive tape for foundation according to claim 7, wherein the airtight pressure-sensitive adhesive tape has a row of a plurality of holes for anchor bolt penetration, the holes being formed in a region extending from a side edge portion of the elastic sheet on a side where no pressure-sensitive adhesive layer is formed before the pressure-sensitive adhesive layer and being aligned parallel to the side edge portion at regulated intervals, the holes for anchor bolt penetration having a slit shape.

9. The airtight pressure-sensitive adhesive tape for foundation according to claim 7, having 1 to 5 rows of the row of holes for anchor bolt penetration.

10. The airtight pressure-sensitive adhesive tape for foundation according to claim 7, wherein the elastic sheet is made of an elastic resin foam.

11. The airtight pressure-sensitive adhesive tape for foundation according to claim 1, wherein the elastic sheet has a durometer E hardness in a range of from 4 to 41 measured in accordance with JIS K 6253 at room temperature.

12. The airtight pressure-sensitive adhesive tape for foundation according to claim 1, wherein the elastic sheet has a moisture permeability of 32 g/m²·24 h or less measured in accordance with JIS Z 0208:1976 at room temperature.

13. The airtight pressure-sensitive adhesive tape for foundation according to claim 1, wherein the elastic sheet has a thickness in a range of from 2 mm to 30 mm.

14. The airtight pressure-sensitive adhesive tape for foundation according to claim 1, wherein the elastic sheet formed of the elastic resin foam has a 50% compressive stress of from 10 kPa to 200 kPa measured in accordance with JIS K 6767 at room temperature.

15. The airtight pressure-sensitive adhesive tape for foundation according to claim 1, wherein the elastic resin comprises an ethylene-propylene-diene rubber or polyethylene.

16. The airtight pressure-sensitive adhesive tape for foundation according to claim 1, wherein the pressure-sensitive adhesive layer comprises an acrylic or rubber-based pressure-sensitive adhesive.

17. The airtight pressure-sensitive adhesive tape for foundation according to claim 1, wherein the pressure-sensitive adhesive layer has a width dimension in a range of from 5 mm to 100 mm.

18. A method of airtight damp-proofing a wooden building, the method comprising:
a step of arranging the elastic sheet of the airtight pressure-sensitive adhesive tape for foundation according to claim 7 between a top surface of a foundation and a bottom surface of a sill such that a portion of the front surface of the elastic sheet extending from the side edge portion on a side where the pressure-sensitive adhesive layer is not formed to the virtual L-shape fold line is in contact with the bottom surface of the sill;
a step of folding up a portion of the elastic sheet extending from the side edge portion on a side where the pressure-sensitive adhesive layer is formed to the virtual L-shape fold line along the virtual L-shape fold line in a direction in which the pressure-sensitive adhesive layer faces inward to bond the pressure-sensitive adhesive layer to the side surface of the sill; and
installing a wall member such that the wall member is in contact with the elastic sheet of the airtight pressure-sensitive adhesive tape for foundation bonded on a side surface of a sill.

19. A building comprising the airtight pressure-sensitive adhesive tape for foundation according to claim 1.
